(19) United States
(12) Patent Application Publication
(10) Pub. No.: US 2006/0129324 A1
(43) Pub. Date: Jun. 15, 2006

(54) Use of quantitative EEG (QEEG) alone and/or other imaging technology and/or in combination with genomics and/or proteomics and/or biochemical analysis and/or other diagnostic modalities, and CART and/or AI and/or statistical and/or other mathematical analysis methods for improved medical and other diagnosis, psychiatric and other disease treatment, and also for veracity verification and/or lie detection applications.

(75) Inventors: Michael D. Rabinoff, San Jose, CA (US); Kaiser K. Fung, New York, NY (US)

Correspondence Address: JEFFREY FURR, 253 N. MAIN STREET, JOHNSTOWN, OH, 43031, US

(73) Assignee: BIOGENESYS, INC., Las Vegas, NV (US)

(21) Appl. No.: 10/905,108

(22) Filed: Dec. 15, 2004

(51) Int. Cl. G06Q 10/00; G06F 19/00

(52) U.S. Cl. 702/19; 705/2

(57) ABSTRACT

This invention relates to a method for significantly increasing the accuracy of predicting and selecting an antidepressant agent, or other pharmacological agent for treatment of a disease state, that will be effective based on pre-treatment or baseline, placebo treatment and/or active treatment, or other post-treatment time period data, early changes quantitative EEG or other brain imaging functional state and/or anatomical data (such as magnetoencephalography (MEG), quantitative MEG (QMEG), fMRI, CAT scan, PET, functional PET, X-ray, etc.), time change/time series, weighted factor, principal component, regional ensemble and/or artificial intelligence analysis. Utilization of such methods may also be applied to enhance individual statement verification and/or lie detection. In addition, such methods can be used to identify physiological state, pathophysiological state, including disease diagnosis, disease progression and/or remission, and other health and/or disease states and changes of interest. Furthermore, the invention may be used to discover novel applications for therapeutic entities, deduce the mode of action of one or more therapeutic entities, improve testing of candidate therapeutic entities, and be used by the pharmaceutical industry or research community to eliminate or select agents or therapeutic modalities for further development as therapeutic agents or treatment modalities.

### TECHNICAL FIELD

The field of this invention is the selection of correct medical diagnosis, selection of the appropriate medication, by brain state and other analysis, for efficacious and timely treatment of psychiatric, neurological and other disease states. In addition, methods described may be used to enhance statement veracity verification and/or lie detection.

### BACKGROUND OF INVENTION

This invention relates to a method for significantly increasing the accuracy of predicting and selecting an antidepressant agent, or other pharmacological agent for treatment of a disease state, that will be effective based on baseline, placebo treatment and/or active treatment data, or other post-treatment time period data, early changes quantitative EEG or other brain imaging functional state and/or anatomical data (such as magnetoencephalography (MEG), quantitative MEG (QMEG), fMRI, CAT scan, PET, functional PET, X-ray, etc.), time change/time series, weighted factor, principal component, regional ensemble and/or artificial intelligence analysis. Utilization of such methods may also be applied to enhance individual statement verification and/or lie detection. In addition, such methods can be used to identify physiological state, pathophysiological state, including disease diagnosis, disease progression and/or remission, and other health and/or disease states and changes of interest. Furthermore, the invention may be used to discover novel applications for therapeutic entities, deduce the mode of action of one or more therapeutic entities, improve testing of candidate therapeutic entities, and be used by the pharmaceutical industry or research community to eliminate or select agents or therapeutic modalities for further development as therapeutic agents or treatment modalities.

### BACKGROUND

Accuracy of prediction of clinical response background, including pharamcogenomics and other issues:

It is of utmost clinical significance to be able to select the best medication for treatment of a disease statement that will be both efficacious and not produce side effects. Publically reported efforts to do so have not been very successful.

Prior experimental results from pharamacogenomics studies in the public literature have been conflicting. That may be because they don't take into account 1). brain activity, 2). multi gene-effects of combination of genes that affect pharmacokinetics and pharmacodynamics, etc. 3). nutritional and environmental factors that affect brain functioning, 4). current body biochemistry. and 5). other psychological and social factors, etc. To generate the very best models, it may be that one must have a comprehensive model to get best results. (i.e. The best models might include biopsychosocial factors and models, including looking at cognitive, behavioral and emotive states). All of these factors don't appear to be needed to predict treatment response, and QEEG analysis methods described herein are highly predictive of treatment response. The combination of pharmacogenomics/proteomics and QEEG results are highly predictive of response prediction and side effect prediction. (However, the addition of nutritional/environmental analysis, lab tests, and psychological/sociological diagnostic testing results may improve predictive accuracy further). The combination of pharmacogenomics/proteomics and QEEG results provides for adequate methodology for personalized medicine for psychiatric, neurological and other conditions, whereby the most effective medicine for interaction with the nervous system state can be selected by various QEEG (or other nervous systems methodology such as MEG) analysis (and experimental evidence of accuracy of selection of effective medication is presented herein), and the potential for side effects is minimized by pharmacogenomics/proteomics analysis.

Pharmcogenomic/proteomic effects may preclude the effectiveness of the actual use of the medication. For example, pharmacokinetic genomic/proteomic effects (including, but not limited to, genes that affect absorption, distribution, metabolism and excretion of the drug) may significantly affect treatment response. If an individual has genes that greatly speed specific drug metabolism, then at standard doses, the concentration may never get high enough to produce treatment response. Conversely, if the individual has genes that lead to very slow drug metabolism, then the concentration in the blood may be too high when using standard doses, and side effects, adverse reactions, and toxicity could develop. Likewise, pharamcodynamic genomic/proteomic effects could lead to poor activity of the medication at desired sites of action in the body, so that there is poor treatment response. Conversely, pharamcodynamic genomic/proteomic effects might lead to increased and too high activity at desired sites of action, producing side effects, adverse effects and toxicity.

CART, Statistical and Al Background Issues:

Researchers in the machine learning community first noticed that combining classifiers often improves the accuracy in prediction [Breiman, Schapire, Quinlan, Diettrich]. To quote Diettrich, “the main discovery is that ensembles are often much more accurate than the individual classifiers that make them up”. Typically, a base classification algorithm is used to obtain a sequence of classifiers; these base classifiers are then combined to create an ensemble. Remarkably, ensembles of diverse types have performed well empirically. In particular, ensembles represent a nice way to aggregate “weak classifiers” [Schapire]. Current research is directed towards comparing different construction methodologies and analyzing why ensembles often yield lower errors.

Two of the most widely studied ensemble procedures are bagging (due to Breiman, a co-inventor of CART) and boosting (due to Freund and Schapire). These two methods both use “unstable” base classifiers which are sensitive to perturbations of the data; both combine classifiers by majority voting. Bagging generates a sequence of classifiers by applying the base algorithm to bootstrap samples of the original data [Breiman]. Bootstrap is a powerful statistical procedure to handle data scarcity [Efron]. Boosting uses the entire set of records in each iteration but over-weights those records that have been poorly classified in the previous iteration [Schapire]. Successful applications have been widely reported, most using decision trees as base classifiers [Quinlan, Diettrich2, Schapire, Breiman].

Ensembles are robust in the sense that they significantly outperform individual classifiers when evaluated over a range of data sets [Quinlan, Breiman]. For instance, when compared to an individual tree classifier, Quinlan (developer of the popular C4.5 tree classification software) reported that bagging performed better than base C4.5 in 24 of 27 data sets, and boosting, on 21 of 27 data sets.

One way to understand how ensembles work is bias-variance decomposition [Breiman]. The error of an ensemble estimator can be split up into two parts: the systematic error (or bias) due to characteristics of the base classification algorithm; and random error (or variance) due to using a specific training set. Combining many classifiers reduces the variance, thereby improving overall accuracy. This situation is analogous to portfolio diversification in finance theory: it is well-known that investing in diverse assets reduces the variance of returns. Ensemble estimation also appeals strongly to our common sense: indeed in our judicial and jury systems, the inventors believe panels are less prone to making mistakes than individuals.

The problem of tree classification of treatment response is particularly suited to the method of ensembles. Firstly, CART is known to be unstable (with respect to perturbations of the data), a prerequisite of several ensemble procedures [Breiman]. Secondly, our individual classifiers are “weak” and so can be strengthened by constructing ensembles. Thirdly, our individual classifiers have relatively uncorrelated errors since each exploits data from a specific brain region, a view supported by current medical knowledge. If errors are correlated, then combining classifiers will only compound the errors made by individual components [Diettrich]. While both bagging and boosting work with the space of observations, our construction applies CART to partitions of the space of variables. Some early results from similar studies are listed in Diettrich's survey.

Computerized systems to accurately produce medical diagnosis has been sought for decades. Such systems may be of value for alerting clinicians to unseen epidemics in a locality or wider geographical area, help clinicians to make or verify diagnosis, and thus improve medical treatment. Machine learning on data sets, and other methods such as CART, might allow software to find relationships and generate hypotheses that may not be recognizable within the current cognitive schema of a clinician or research community. Machine learning, or other methods such as CART, utilized to monitor for new trends in pathology (i.e morbidity, mortality, etc.) within a community serviced by a data system might find epidemiological trends before they are seen by clinicians. Such systems are thought to be of importance for the medical and public health community, and historically there has been an ongoing effort to develop and improve of such methods, so that they might be useable for medical and public health use.

Efforts to effectively develop veracity verification and/or lie detection methods that do not involve the infliction of pain or psychological coercion, and that to the least extent possible affect the individual's freedom, and stay within the boundaries of the law, could be of use to individuals, corporations and governments. Improvements of such methods have historically been sought.

### PRIOR ART

U.S. Pat. No. 6,731,975 by Viertio-Oja, et al. and issued on May 4, 2004 is for a method and apparatus for determining the cerebral state of a patient with fast response. It discloses a method and apparatus for ascertaining the cerebral state of a patient. The method/apparatus may find use in ascertaining the depth of anesthesia of the patient.

U.S. Pat. No. 6,631,291 by Viertio-Oja, et al. and issued on Oct. 7, 2003 is for a closed loop drug administration method and apparatus using EEG complexity for control purposes. It discloses a closed loop method and apparatus for controlling the administration of a hypnotic drug to a patient. Electroencephalographic (EEG) signal data is obtained from the patient.

U.S. Pat. No. 6,605,072 by Struys, et al. and issued on Aug. 12, 2003 and U.S. Pat. No. 6,599,281 by Struys, et al. and issued on Jul. 29, 2003 are for a system and method for adaptive drug delivery. It discloses a system and method for controlling the administration of medication to a patient utilizes adaptive feedback to achieve and maintain a target effect in said patient. A sensor package having one or more sensors is used to sense an attribute of the patient and to provide a parameter indicating the attribute being sensed.

U.S. Pat. No. 6,549,804 by Osorio, et al. and issued on Apr. 15, 2003 is for a system for the prediction, rapid detection, warning, prevention or control of changes in activity states in the brain of a subject. It discloses a system analyzes signals representative of a subject's brain activity in a signal processor for information indicating the subject's current activity state and for predicting a change in the activity state.

U.S. Pat. No. 6,493,577 by Williams and issued on Dec. 10, 2002 is for a method and system for detecting white matter neural injury and predicting neurological outcome particularly for preterm infants. It discloses a method for detecting white matter neural injury and predicting neurological outcome for a patient comprises acquiring EEG signal(s) from the surface of the head of the patient, and analyzing the frequency distribution or content of the signal(s) to produce output information indicative of cerebral white matter injury for the patient. Loss or reduction of activity in the upper portion or spectral edge of the EEG frequency domain particularly in the immature brain is predictive of neural dysfunction.

U.S. Pat. No. 6,338,713 by Chamoun, et al. and issued on Jan. 15, 2002 is for system and method for facilitating clinical decision making. It discloses a system and method for providing information to the user of a medical monitoring or diagnostic device to aid in the clinical decision making process.

U.S. Pat. No. 6,309,361 by Thornton and issued on Oct. 30, 2001 is for a method for improving memory by identifying and using QEEG parameters correlated to specific cognitive functioning. It discloses where mental abilities are labeled with terms such as memory, problem solving, spelling, etc. and can be measured by psychological measures such as recall score, etc. The physical correlates of brain functioning employ such measures as blood flow, electrophysiological events, etc. The relationship between these different scientific domains is called the mind-body problem. The submitted patent addresses the empirically obtained correlative relationships between a number of cognitive capabilities and the Quantitative EFG (QEEG) measures (coherence, phase, magnitude, etc.) during cognitive activation conditions.

U.S. Pat. No. 6,231,560 by Bui, et al. and issued on May 15, 2001 is for a method and apparatus for automatically controlling the level of medication. It discloses a method and apparatus which captures relevant information pertaining to a patient's physiological conditions, automatically adjusts the amount of medication to optimize the treatment of pain and improve the patient's quality of life.

U.S. Pat. No. 6,097,980 by Monastra, et al. and issued on Aug. 1, 2000 is for a quantitative electroencephalographic (QEEG) process and apparatus for assessing attention deficit hyperactivity disorder. It discloses a simplified, quantitative electroencephalographic (QEEG) technique and apparatus for testing and assessing individuals for Attention Deficit Hyperactivity Disorder (ADHD).

U.S. Pat. No. 5,995,868 by Dorfmeister, et al. and issued on Nov. 30, 1999 is for a system for the prediction, rapid detection, warning, prevention, or control of changes in activity states in the brain of a subject. It discloses a system analyzes signals representative of a subject's brain activity in a signal processor for information indicating the subject's current activity state and for predicting a change in the activity state.

U.S. Pat. No. 5,230,346 by Leuchter, et al. and issued on Jul. 27, 1993 is for diagnosing brain conditions by quantitative electroencephalography. It discloses determining the brain condition of a human between normal and abnormal as determined by dementia, and selectively between dementia of the Alzheimer's-type and multi-infarct dementia is effected.

There is still room for improvement in the art.

### SUMMARY OF INVENTION

The present invention is a compilation of novel medication treatment strategies, and application of new quantitative EEG alone and/or in combination with other imaging technology and/or genomics and/or proteomics and/or biochemical analysis, and CART, statistical and other Al analysis methods for improved medical diagnosis, psychiatric and other disease treatment, and also for veracity verification and/or lie detection. The present invention demonstrate application of Al, CART and other analysis methods to medical diagnosis, as well as application of new methods of QEEG analysis to predict effectiveness of, and select, antidepressant and other nervous system active medications for treatment of patients, and to accurately predict at baseline (i.e. before treatment has been initiated) or within 2 to 7 days or earlier if the antidepressant (or other nervous system or other medical illness treatment) will be effective once treatment has started, and application of QEEG and other methods for veracity verification and/or lie detection applications.

This invention relates to a method for significantly increasing the accuracy of predicting and selecting an antidepressant agent, or other pharmacological agent for treatment of a disease state, that will be effective based on pre-treatment or baseline, one week single blind placebo treatment (i.e. wash-in period) and/or 2 and 7 day or other post-treatment time period data, early changes quantitative EEG or other brain imaging functional state data (such as magnetoencephalography, fMRI, etc), time change/time series, weighted factor, principal component, regional ensemble and/or artificial intelligence analysis. Utilization of such methods may also be applied to enhance individual statement veracity verification and/or lie detection.

### BRIEF DESCRIPTION OF DRAWINGS

Without restricting the full scope of this invention, the preferred form of this invention is illustrated in the following drawings:

FIG. 1 shows performance of 16 models using weighted factor variables

FIG. 2 shows tree structures for weighted factor variables

FIG. 3 shows plots of selected principal components from PCA analysis;

FIG. 4A: shows relative power only model results;

FIG. 4B; shows the tress structures for the best models that only use relative QEEG data;

FIG. 5 shows the comparison of R only and ARZ models results;

FIG. 6 shows the regional data for placebos CART/ARZ results;

FIG. 7 shows the regional data for placebos CART/ARZ trees with splitting variables and values;

FIG. 8A shows the range of errors over placebo models;

FIG. 8B displays an Electrode Montage;

FIG. 9A shows the 10 best splitting variables at baseline when drug was eliminated from variables;

FIG. 9B shows the optimal tree classifier for classifying responders into drug groups using baseline predictors;

FIG. 10a and FIG. 10b shows the optimal tree classifiers using baseline data for classifying patients into drug treatment responder vs. non-responder for patients treated with fluoxetine or reboxetine;

FIG. 11 displays the six best tree classifiers using one week single blind placebo treatment, 2 day and 7 day data for patients treated with a drug;

FIG. 12 displays the ten best splitting variables using one week single blind placebo treatment, 2 day and 7 day data for patients treated with a drug;

FIG. 13 displays nine acceptable models, i.e. “second-best” models with cross-validation errors under 40%; in these models the best splitting variable was removed from consideration, this forcing the algorithm to split the data using successively ranked variables;

FIG. 14a and 14b shows the optimal tree classifiers using one week single blind placebo treatment data for classifying patients into drug treatment responder vs. non-responder for patients treated with fluoxetine or reboxetine, along with one week single blind placebo treatment optimal tree classifier attributes;

FIG. 15 shows optimal tree classifiers attributes using 2 day data for classifying patients into drug treatment responder vs. non-responder;

FIG. 16a and 16b displays optimal tree classifiers using 2 day data for classifying patients into drug treatment responder vs. non-responder for patients treated with reboxetine or all drugs;

FIG. 17 displays a collection of optimal tree classifiers using baseline, one week single blind placebo treatment, 2 day and 7 day data;

FIG. 18 lists the top regions according to how many 95% confidence level variables were found when using t-tests for each drug treatment;

FIG. 19 displays Fluoxetine results using t-test p-value results to separate patients into responders vs. non-responders by confidence level;

FIG. 20 displays Fluoxetine 95% variables by group;

FIG. 21 displays Reboxetine results using t-test p-value results to separate patients into responders vs. non-responders by confidence level;

FIG. 22 displays Reboxetine 95% variables by group;

FIG. 23 displays Veniafaxine results using t-test p-value results to separate patients into responders vs. non-responders by confidence level;

FIG. 24 displays Veniafaxine 95% by group;

FIG. 25 displays Fluoxetine new variables as function of weighted factor value graphs;

FIG. 26 displays Fluoxetine new 95% variables as function of weighted factor tables;

FIG. 27 displays Fluoxetine new 95% variables by group;

FIG. 28 displays Reboxetine new variables function of weighted factor value graphs;

FIG. 29 displays Reboxetine new 95% variables as function of weighted factor tables;

FIG. 30 displays Reboxetine new 95% variables as function of weighted factor tables;

FIG. 31 displays Reboxetine new 95% variables by group;

FIG. 32 displays Veniafaxine new variables function of weighted factor value graphs;

FIG. 33 displays Veniafaxine new 95% variables as function of weighted factor tables;

FIG. 34 displays Veniafaxine new 95% variables by group;

FIG. 35A shows principal components that qualified as 95% variables

FIG. 35B shows a comparison of PCA to ARZ tree classifiers;

FIG. 36 displays the performance of individual region expert tree models versus small panel model;

FIG. 37 displays the range of errors over individual region expert tree models and panel models;

FIG. 38 shows table specifying ensemble estimators for fluoxetine treatment responders vs. non-responders;

FIG. 39 displays predictions for fluoxetine treatment responders vs. non-responders by regional experts and panel;

FIG. 40 displays example of prediction errors for fluoxetine treatment responders vs. non-responders by regional experts and panel;

FIG. 41 displays prediction errors for fluoxetine treatment responders vs. non-responders by expert classifier, and total number of errors per patient by all of the individual region experts (while the panel model had no errors);

FIG. 42 displays the performance of full panel versus individual regional expert models in terms of error rates;

FIG. 43 displays the error rates for twenty individual regional experts models in comparison to the full panel model;

FIG. 44 displays the panel and its constituent tress;

FIG. 45 compares re-substitution error rates for regional experts and panel across models;

FIG. 46 displays a table comparing regional experts and panel across models;

FIG. 47 displays a graph comparing regional experts and small panel across models in terms of error rates; and

FIG. 48 shows the variance across individual region expert and panel models for re-substitution errors.

### DETAILED DESCRIPTION

The following description is demonstrative in nature and is not intended to limit the scope of the invention or its application of uses.

There are a number of significant design features and improvements incorporated within the invention.

The current invention is a novel medication treatment and delivery strategies, and application of new QEEG analysis methods for improved psychiatric and other disease treatment, and for veracity verification and/or lie detection.

The application contains use of Al to medical diagnosis, to evaluate if the inventors can improve accuracy of predicting who will respond to an anti-depressant based an Al, CART, statistical and other analysis of quantitative EEG (or other brain state) data. First models used support vector machines, CART and enhanced statistical analysis. There is also use of medical data with different Al models competing to create best model for prediction of medical diagnosis and selection of medication to effectively treat psychiatric, neurological, autoimmune, rheumatological or other disease conditions.

The following examples are offered by way of illustration and not by way of limitation.

### EXPERIMENTAL

### Example 1

Statistical analyses which provide extremely accurate model to predict if the patient is responding to a antidepressant medication treatment at 2 or 7 days:

For models that are extremely accurate at baseline and/or one week single blind placebo treatment, predicting which agent a patient will respond to (whether of SSRI, SNRI, or NRI, or any other class). For models which are extremely accurate at 2 days and 7 days of treatment in predicting if the individual will actually respond to the specific medication he/she is taking. Of note, delta, theta, alpha, beta are standard EEG brain wave regions. _a stands for absolute electrical level, _r stands for relative % of all brain wave regions the electrical activity of that particular region is, _z if the cordance value as determined by Saxena/Leuchter/Cook newer calculations/formula that is currently used (as that has been determined to be much more accurate than results from prior published formulas, and what was presented in Leuchter and Cook patents). _b is baseline, _w is wash in (after single blind placebo treatment for 1 week), _{—}2 is 2 days, _{—}7 is 7 days, _{—}28 is 28 days, and _{—}56 is at 56 days of treatment. Thus, alpha_a_{—}7, is the absolute alpha brain wave score at 7 days, for the specific point or region as scored by the model.

The ultimate significant model comes from an analysis of the combination of significant results from multiple regions of the brain.

As examples of significant results for all medications combined for 2 and 7 days:

For anterior cingulate region (AC), significant findings noted for theta_z_{—}2, alpha_a_{—}7, delta_r_{—}7, alpha_r_{—}7, and delta_z_{—}7.

For coronal region (C), alpha_a_{—}7, alpha_r_{—}7, and delta_z_{—}7 show significant differences.

For frontal region (F), theta_z_{—}2, beta_z_{—}2, alpha_a_{—}7, alpha_r_{—}7, and beta_z_{—}7 show significant differences.

For left coronal region (LC), alpha_z_{—}2 shows significant differences.

For left dorsolateral prefrontal cortex region (LDLPFC), alpha_a_{—}7, theta_r_{—}7, and theta_z_{—}7 show significant differences.

For right occipito-parietal region (ROP), theta_z_{—}7, alpha_z_{—}2, and alpha_r_{—}7 show significant differences.

For left temporal region (LT), delta_r_{—}7 shows significant differences.

For left occipital region (O), alpha_z_{—}2, and alpha_r_{—}7 show significant differences.

For right coronal region (RC), alpha_a_{—}7, alpha_r_{—}7, and theta_z_{—}7 show significant differences.

For left language region (LLANG), total_r_{—}2, alpha_z_{—}2, alpha_a_{—}7, and alpha_r_{—}7 show significant differences.

For left parietal region (LP), beta_r_{—}2, total_r_{—}2, alpha_z_{—}2, alpha_r_{—}7, and delta_z_{—}7 show significant differences.

For left occipito-parietal region (LOP), alpha_r_{—}7 shows significant differences.

For prefrontal cortex region (PFC), theta_z_{—}7 shows significant differences.

For right dorsolateral prefrontal cortex region (RDLPFC), theta_r_{—}7, alpha_a_{—}7, alpha_r_{—}7, and theta_z_{—}7 show significant differences.

For right parietal region (RP), delta_z_{—}2, beta_z_{—}2, alpha_a_{—}7, alpha_r_{—}7, theta_z_{—}7, and beta_z_{—}7 show significant differences.

For right perceptual region (RPERC), delta_z_{—}2, beta_z_{—}2, theta_r_{—}7, alpha_r_{—}7, theta_z_{—}7, and beta_z_{—}7 show significant differences.

For right temporal region (RT), delta_z_{—}2, and alpha_r_{—}7 show significant differences.

For sagittal region (S), delta_r_{—}7, alpha_r_{—}7, alpha_a_{—}7, and theta_z_{—}7 show significant differences.

Results used a file, created by Biogenesys program modeling code that computes, and evaluates, the change from baseline values for each brain wave region for each type of score (a,r,z), for each time, for each brain region, and the predictive significance of each combination, and of modeling for best combination models. Regional computations were done by averaging results for combinations of points as follows:

AC: FC1, FC2, Cz

ACPlus: FC1, FC2, Cz, Fz

C: C3, C4, Cz, T3, T4

F: AF1, AF2

FAC: AF1, AF2, Fz, FC1, FC2

FPFCAC: AF1, AF2, Fz, PF1, PF2, PFz, FC1, FC2

FPlus: AF1, AF2, Fz

FPlusAll: AF1, AF2, Fz, PF1, PF2, PFz

LC: C3, T3

LDLPFC: F3, F7

LDLPFCPlus: F3, F7, FC5

LLANG: C3, CP1, CP5, F7, FC5, P3, T3, T5

LOP: O1, PO1, PO7

LP: CP1, CP5, P3

LT: T3, T5

O: O1, O2, Oz, PO1, PO2, PO7, PO8

PFC: FP1, FP2, FPz

RC: C4, T4

RDLPFC: F4, F8

RDLPFCPlus: F4, F8, FC6

ROP: O2, PO2, PO8

RPERC: C4, CP2, CP6, F8, FC6, P4, T4, T6

RP: CP2, CP6, P4

RT: T4, T6

S: Cz, Fz, Pz

SPlus: Cz, Fz, FPz, Pz, Oz

Thus of note, significant findings are seen with absolute, relative and or z scores, and while the very best significance comes from a predictive model including all three parameters, that prediction accuracy over 95—over 99% can come with a model using just the standard absolute and relative scores. Modeling of the interaction of region of brain, brain wave region (standard segment/spectrum of electrical activity), _z, _a or _r data, and time series analysis provides extremely accurate and robust models.

Similar examples of significant findings exist for specific medications of different mechanism of action (fluoxetine, venlafaxine, reboxetine), for prediction of treatment success with a specific agent and/or class of medication based on QEEG at baseline and/or wash in, or prediction that treatment will be successful based on brain wave changes at 2 and/or 7 days of treatment. However, these results from standard statistical analysis, while significant, are not as significant as results utilizing CART analysis, which is at least and order or magnitude, to orders of magnitude more significant in the combination of accuracy and reduction of cross-validation and re-substitution error rates, making the CART methods more practical for use in clinical practice, and allowing earlier use to effectively select medication

Per single point CART analysis very significant predictive models were created. Use of _z score for individual points were most predictive, followed by _a scores, with few _r scores being predictive when only point data was used. Combination models were more predictive. Region data was more predictive for _z, _a and/or _r.

Research demonstrated that regional and single electrode QEEG analysis demonstrated significant accuracy on predicting antidepressant agent that was effective based on baseline, one week single blind placebo treatment, 2 and 7 day data, early changes QEEG data, and time change/time series analysis. These results were demonstrated and confirmed by statistical T-test, linear regression and discriminant analysis.

T-Test Report

Popula Only Drug=T

Assum 1. We assume that the variables are normally distribut

2. Two groups (Responders vs. Non-responders) are independent each oth

Hypoth Ho: The two group means are same. (two-sided test)

Ha: The two group means are not same.

Signifi alpha=0.05

| | | | T-test | | | | | Equality of Variances | | | | |
|---|---|---|---|---|---|---|---|---|---|---|---|---|
| armstu | Region | Variable | Method | Variances | DF | t Value | Pr > \|t\| | Method | Num DF | Den DF | F Value | Pr > F |

Fluoxetine

| AC | delta_z_7 | Pooled | Equal | 11 | 2.84 | 0.0162 | Folded F | 5 | 6 | 1.25 | 0.7826 |
|---|---|---|---|---|---|---|---|---|---|---|---|
| C | alpha_z_2 | Pooled | Equal | 11 | 2.68 | 0.0214 | Folded F | 6 | 5 | 3.42 | 0.1983 |
| F | theta_z_w | Pooled | Equal | 11 | 3.22 | 0.0082 | Folded F | 5 | 6 | 3 | 0.2136 |
| LC | None | | | | | | | | | | |
| LDLPFC | theta_r_7 | Pooled | Equal | 11 | 2.92 | 0.014 | Folded F | 6 | 5 | 1.33 | 0.7708 |
| | beta_r_7 | Pooled | Equal | 11 | 2.29 | 0.0426 | Folded F | 5 | 6 | 1.83 | 0.483 |
| LLANG | total_r_w | Pooled | Equal | 11 | −2.38 | 0.0362 | Folded F | 6 | 5 | 1.8 | 0.5365 |
| LOP | alpha_z_2 | Pooled | Equal | 11 | −2.33 | 0.0395 | Folded F | 6 | 5 | 2.14 | 0.4216 |
| LP | total_r_w | Pooled | Equal | 11 | −2.25 | 0.0462 | Folded F | 6 | 5 | 1.52 | 0.6634 |
| LT | None | | | | | | | | | | |
| O | alpha_r_2 | Pooled | Equal | 11 | −2.27 | 0.0447 | Folded F | 6 | 5 | 2.19 | 0.4083 |
| PFC | theta_z_w | Pooled | Equal | 11 | 4.25 | 0.0014 | Folded F | 6 | 5 | 2.38 | 0.3595 |
| | theta_r_7 | Pooled | Equal | 11 | 2.3 | 0.0417 | Folded F | 6 | 5 | 2.16 | 0.4167 |
| | beta_r_7 | Pooled | Equal | 11 | 3.24 | 0.0078 | Folded F | 5 | 6 | 3.76 | 0.1377 |
| | theta_z_7 | Pooled | Equal | 11 | 3.5 | 0.005 | Folded F | 6 | 5 | 1.54 | 0.6536 |
| RC | None | | | | | | | | | | |
| RDLPFC | delta_z_b | Pooled | Equal | 11 | 2.75 | 0.019 | Folded F | 6 | 5 | 2.42 | 0.3511 |
| | beta_z_w | Satterthw | Unequal | 7.9 | 2.61 | 0.0317 | Folded F | 6 | 5 | 7.02 | 0.0493 |
| | theta_r_7 | Pooled | Equal | 11 | 2.27 | 0.0443 | Folded F | 6 | 5 | 1.46 | 0.6963 |
| ROP | alpha_r_2 | Pooled | Equal | 11 | −2.21 | 0.0489 | Folded F | 6 | 5 | 3.08 | 0.2372 |
| RP | beta_z_b | Pooled | Equal | 11 | 2.46 | 0.0317 | Folded F | 6 | 5 | 3.49 | 0.1914 |
| | theta_r_7 | Pooled | Equal | 11 | 2.23 | 0.0473 | Folded F | 6 | 5 | 1.18 | 0.8735 |
| RPERC | theta_r_7 | Pooled | Equal | 11 | 2.2 | 0.05 | Folded F | 6 | 5 | 1.37 | 0.7458 |
| | theta_z_7 | Pooled | Equal | 11 | −2.46 | 0.0316 | Folded F | 6 | 5 | 2.18 | 0.4107 |
| RT | delta_z_2 | Pooled | Equal | 11 | −2.51 | 0.029 | Folded F | 6 | 5 | 2.64 | 0.3053 |
| | delta_z_7 | Pooled | Equal | 11 | −2.67 | 0.022 | Folded F | 6 | 5 | 2.17 | 0.4127 |
| S | delta_z_w | Pooled | Equal | 11 | 2.9 | 0.0145 | Folded F | 5 | 6 | 1.39 | 0.6914 |
| | theta_z_w | Pooled | Equal | 11 | −3.11 | 0.01 | Folded F | 6 | 5 | 1.6 | 0.621 |
| | delta_z_7 | Pooled | Equal | 11 | 2.71 | 0.0201 | Folded F | 5 | 6 | 1.81 | 0.4903 |
| | theta_z_7 | Pooled | Equal | 11 | −2.21 | 0.0494 | Folded F | 5 | 6 | 1.48 | 0.6434 |

Velafaxine

| AC | None | | | | | | | | | | |
|---|---|---|---|---|---|---|---|---|---|---|---|
| C | total_r_w | Pooled | Equal | 7 | −2.45 | 0.0440 | Folded F | 3 | 4 | 3.87 | 0.2243 |
| F | None | | | | | | | | | | |
| LC | None | | | | | | | | | | |
| LDLPFC | delta_z_7 | Pooled | Equal | 7 | −2.69 | 0.0311 | Folded F | 4 | 3 | 4.01 | 0.2832 |
| LLANG | delta_z_b | Pooled | Equal | 7 | −2.8 | 0.0265 | Folded F | 3 | 4 | 3.34 | 0.2741 |
| | total_r_w | Satterthw | Unequal | 3.44 | −3.5 | 0.0319 | Folded F | 3 | 4 | 11.02 | 0.0421 |
| LOP | beta_r_w | Pooled | Equal | 7 | −2.82 | 0.0257 | Folded F | 3 | 4 | 6.46 | 0.1034 |
| LP | total_r_w | Pooled | Equal | 7 | −3.05 | 0.0186 | Folded F | 3 | 4 | 4.04 | 0.2111 |
| LT | beta_r_w | Pooled | Equal | 7 | −3.82 | 0.0065 | Folded F | 3 | 4 | 6.06 | 0.1145 |
| | total_r_w | Pooled | Equal | 7 | −2.91 | 0.0226 | Folded F | 3 | 4 | 1.52 | 0.6794 |
| O | beta_r_w | Pooled | Equal | 7 | −2.64 | 0.0335 | Folded F | 3 | 4 | 4.24 | 0.1969 |
| PFC | alpha_z_b | Pooled | Equal | 7 | −2.85 | 0.0246 | Folded F | 4 | 3 | 1.03 | 1 |
| | alpha_r_2 | Pooled | Equal | 7 | 2.5 | 0.0409 | Folded F | 4 | 3 | 1.61 | 0.7252 |
| RC | theta_z_b | Pooled | Equal | 7 | −2.82 | 0.0258 | Folded F | 4 | 3 | 8.84 | 0.1042 |
| RDLPFC | None | | | | | | | | | | |
| ROP | beta_r_w | Satterthw | Unequal | 3.47 | −2.37 | 0.087 | Folded F | 3 | 4 | 10.27 | 0.0476 |
| | total_r_2 | Pooled | Equal | 7 | −2.64 | 0.0334 | Folded F | 4 | 3 | 1.07 | 0.994 |
| RP | beta_z_b | Satterthw | Unequal | 4.03 | −2.88 | 0.0449 | Folded F | 4 | 3 | 376.9 | 0.0004 |
| | total_r_w | Satterthw | Unequal | 3.25 | −3.05 | 0.0498 | Folded F | 3 | 4 | 19.48 | 0.0151 |
| | delta_z_2 | Pooled | Equal | 7 | −2.74 | 0.0287 | Folded F | 4 | 3 | 4.9 | 0.2228 |
| RPERC | total_r_w | Pooled | Equal | 7 | −3.45 | 0.0107 | Folded F | 3 | 4 | 1.9 | 0.5409 |
| RT | total_r_w | Pooled | Equal | 7 | −2.78 | 0.0274 | Folded F | 3 | 4 | 1.33 | 0.7663 |
| | total_r_2 | Pooled | Equal | 7 | −2.7 | 0.0306 | Folded F | 4 | 3 | 1.98 | 0.6011 |
| S | delta_z_w | Pooled | Equal | 7 | −2.44 | 0.0446 | Folded F | 4 | 3 | 1.1 | 0.974 |
| | alpha_z_2 | Pooled | Equal | 7 | 3.59 | 0.0089 | Folded F | 3 | 4 | 5.74 | 0.1244 |

Reboxetine

| AC | delta_z_w | Pooled | Equal | 23 | 3.17 | 0.0042 | Folded F | 10 | 13 | 1.19 | 0.7537 |
|---|---|---|---|---|---|---|---|---|---|---|---|
| | alpha_a_7 | Pooled | Equal | 23 | −2.54 | 0.0181 | Folded F | 10 | 13 | 1.82 | 0.3103 |
| | alpha_r_7 | Pooled | Equal | 23 | −2.15 | 0.0425 | Folded F | 13 | 10 | 1.19 | 0.795 |
| C | alpha_r_w | Pooled | Equal | 23 | 2.19 | 0.0386 | Folded F | 10 | 13 | 1.36 | 0.5907 |
| | alpha_a_7 | Pooled | Equal | 23 | −2.72 | 0.0122 | Folded F | 10 | 13 | 2.19 | 0.1863 |
| | delta_z_7 | Pooled | Equal | 23 | 2.46 | 0.022 | Folded F | 13 | 10 | 2.25 | 0.2042 |
| F | beta_z_2 | Pooled | Equal | 23 | −2.14 | 0.0428 | Folded F | 10 | 13 | 1.16 | 0.7822 |
| LC | alpha_r_w | Pooled | Equal | 23 | 2.6 | 0.0161 | Folded F | 10 | 13 | 1.61 | 0.4154 |
| | total_r_w | Pooled | Equal | 23 | −2.14 | 0.043 | Folded F | 10 | 13 | 1.58 | 0.4339 |
| | total_r_7 | Pooled | Equal | 23 | −2.31 | 0.0304 | Folded F | 10 | 13 | 1.82 | 0.3092 |
| LDLPFC | total_a_w | Pooled | Equal | 23 | 2.19 | 0.0387 | Folded F | 10 | 13 | 2.22 | 0.1794 |
| | alpha_a_7 | Pooled | Equal | 23 | −2.24 | 0.0354 | Folded F | 10 | 13 | 1.72 | 0.358 |
| LLANG | alpha_r_w | Pooled | Equal | 23 | 2.23 | 0.0355 | Folded F | 10 | 13 | 1.5 | 0.4864 |
| | alpha_a_7 | Pooled | Equal | 23 | −2.15 | 0.0423 | Folded F | 10 | 13 | 2.78 | 0.0868 |
| LOP | alpha_a_w | Pooled | Equal | 23 | 2.33 | 0.0291 | Folded F | 10 | 13 | 2.43 | 0.1368 |
| | total_a_w | Pooled | Equal | 23 | 2.13 | 0.0439 | Folded F | 10 | 13 | 3.14 | 0.0565 |
| | alpha_r_w | Pooled | Equal | 23 | 2.1 | 0.0469 | Folded F | 13 | 10 | 1.44 | 0.571 |
| LP | alpha_r_w | Pooled | Equal | 23 | 2.35 | 0.0278 | Folded F | 10 | 13 | 1.04 | 0.9247 |
| LT | total_r_w | Satterthw | Unequal | 14 | −2.13 | 0.0512 | Folded F | 10 | 13 | 3.92 | 0.0241 |
| | theta_r_7 | Pooled | Equal | 23 | 2.1 | 0.047 | Folded F | 10 | 13 | 1.67 | 0.3794 |
| O | None | | | | | | | | | | |
| PFC | beta_z_b | Pooled | Equal | 23 | 2.34 | 0.0282 | Folded F | 10 | 13 | 2.67 | 0.1 |
| | beta_z_2 | Pooled | Equal | 23 | −2.13 | 0.0443 | Folded F | 13 | 10 | 1.09 | 0.9087 |
| | beta_z_7 | Pooled | Equal | 23 | −2.34 | 0.0282 | Folded F | 10 | 13 | 2.67 | 0.1 |
| RC | alpha_z_w | Pooled | Equal | 23 | 2.49 | 0.0203 | Folded F | 13 | 10 | 2.45 | 0.1611 |
| | beta_z_2 | Pooled | Equal | 23 | 2.65 | 0.0144 | Folded F | 10 | 13 | 2.38 | 0.1451 |
| | alpha_a_7 | Pooled | Equal | 23 | −2.98 | 0.0067 | Folded F | 10 | 13 | 1.54 | 0.457 |
| | alpha_r_7 | Pooled | Equal | 23 | −2.54 | 0.0181 | Folded F | 13 | 10 | 1.21 | 0.7748 |
| RDLPFC | alpha_r_7 | Pooled | Equal | 23 | −2.59 | 0.0162 | Folded F | 13 | 10 | 2.68 | 0.1256 |
| | theta_z_7 | Pooled | Equal | 23 | 2.15 | 0.0421 | Folded F | 13 | 10 | 2.49 | 0.1547 |
| ROP | theta_z_7 | Pooled | Equal | 23 | −2.28 | 0.0319 | Folded F | 10 | 13 | 1.09 | 0.8643 |
| RP | delta_z_b | Pooled | Equal | 23 | 2.57 | 0.0172 | Folded F | 10 | 13 | 2.3 | 0.1621 |
| | beta_z_b | Pooled | Equal | 23 | −3.69 | 0.0012 | Folded F | 13 | 10 | 1.35 | 0.6397 |
| | delta_r_w | Satterthw | Unequal | 20.4 | −2.26 | 0.035 | Folded F | 13 | 10 | 3.7 | 0.045 |
| | alpha_r_w | Pooled | Equal | 23 | 2.12 | 0.0446 | Folded F | 13 | 10 | 1.46 | 0.5559 |
| | delta_z_w | Pooled | Equal | 23 | −2.96 | 0.007 | Folded F | 10 | 13 | 2.48 | 0.1267 |
| | beta_z_w | Pooled | Equal | 23 | 4.72 | <.0001 | Folded F | 13 | 10 | 2.42 | 0.1678 |
| | delta_z_2 | Pooled | Equal | 23 | −2.53 | 0.0189 | Folded F | 13 | 10 | 1.14 | 0.8476 |
| | beta_z_2 | Pooled | Equal | 23 | 4.27 | 0.0003 | Folded F | 13 | 10 | 2.63 | 0.1316 |
| | alpha_a_7 | Satterthw | Unequal | 14.3 | −2.2 | 0.0446 | Folded F | 10 | 13 | 3.61 | 0.0334 |
| | theta_z_7 | Pooled | Equal | 23 | −3.35 | 0.0028 | Folded F | 13 | 10 | 1 | 1 |
| | beta_z_7 | Pooled | Equal | 23 | 3.69 | 0.0012 | Folded F | 13 | 10 | 1.35 | 0.6397 |
| RPERC | delta_z_b | Satterthw | Unequal | 19.2 | 2.12 | 0.0473 | Folded F | 13 | 10 | 4.64 | 0.0201 |
| | beta_z_b | Pooled | Equal | 23 | −2.19 | 0.0386 | Folded F | 13 | 10 | 1.51 | 0.5208 |
| | alpha_r_w | Pooled | Equal | 23 | 2.19 | 0.039 | Folded F | 10 | 13 | 1.05 | 0.9201 |
| | delta_z_w | Pooled | Equal | 23 | −2.21 | 0.0374 | Folded F | 10 | 13 | 1.29 | 0.6566 |
| | alpha_z_w | Pooled | Equal | 23 | 2.07 | 0.0494 | Folded F | 13 | 10 | 2.26 | 0.2031 |
| | beta_z_w | Pooled | Equal | 23 | 2.09 | 0.048 | Folded F | 10 | 13 | 1.61 | 0.4157 |
| | delta_z_2 | Satterthw | Unequal | 19.5 | −2.19 | 0.0406 | Folded F | 13 | 10 | 4.41 | 0.0242 |
| | beta_z_2 | Pooled | Equal | 23 | 4.93 | <.0001 | Folded F | 13 | 10 | 1.23 | 0.7561 |
| | alpha_a_7 | Pooled | Equal | 23 | −2.51 | 0.0195 | Folded F | 10 | 13 | 2.06 | 0.2209 |
| | alpha_r_7 | Pooled | Equal | 23 | −2.13 | 0.044 | Folded F | 13 | 10 | 3.08 | 0.0821 |
| | beta_z_7 | Pooled | Equal | 23 | 2.19 | 0.0386 | Folded F | 13 | 10 | 1.51 | 0.5208 |
| RT | alpha_r_w | Pooled | Equal | 23 | 2.3 | 0.0308 | Folded F | 10 | 13 | 2.52 | 0.1205 |
| | beta_z_2 | Pooled | Equal | 23 | 2.46 | 0.0217 | Folded F | 13 | 10 | 1.14 | 0.847 |
| S | alpha_a_7 | Pooled | Equal | 23 | −2.7 | 0.0127 | Folded F | 10 | 13 | 1.69 | 0.3731 |
| | total_a_7 | Pooled | Equal | 23 | −2.07 | 0.0497 | Folded F | 10 | 13 | 1.36 | 0.5963 |
| | alpha_r_7 | Pooled | Equal | 23 | −2.54 | 0.0185 | Folded F | 13 | 10 | 1.42 | 0.5826 |

### Example 2

Additional research shows that CART analysis of regional QEEG data is effective at predicting which antidepressant (using baseline, one week single blind placebo treatment, 2 or 7 day data, or change from baseline data) will cause a treatment response in the patient.

Here, additional research is presented which shows that

1). complete accuracy can be obtained in predicting response to medication at one week single blind placebo treatment, 2 days or 7 days, depending on medication (and even in cases at baseline).

2). Significant findings were found with standard T-test methods with cordance, absolute and relative regional (and single point) data, as previously reported in prior provisional patent applications or document disclosures listed above. However, much more significant and stable results were obtained with ensemble and PCA analysis, with significance demonstrated earlier in time, and with much lower re-substitution and cross validation error rates.

3). Contrary to prior results with single point data analysis, which showed that cordance results were superior to absolute value data, which was far superior to relative data results (which offered little or no value: an analysis of all variables for importance in developing CART models showed that 22 cordance variables were of importance, 6 absolute variables were of importance, and no relative values were of importance), that with use of time-series regional principal components analysis (PCA) or panel/ensemble analysis with CART, of change from baseline, that relative data can be used about as effectively as cordance data in accurately predicting response, and both were found to be far superior in PCA or panel/ensemble analysis to use of absolute data, which was essentially useless in PCA analysis for predicting response for fluoxetine and venlafaxine, but had some value for predicting response with reboxetine.

4). Accurate results were obtained with PCA and panel/ensemble analysis of relative (and/or absolute data), without the need for cordance calculation. However, use of cordance data also produced excellent results.

5). While panel analysis described below was found to be most effective, PCA analysis as described below showed that the assumptions of the formulas used for cordance calculations are somewhat arbitrary and do not provide the best results in predicting treatment response, that instead of a 2 axis method, other methods, such as utilizing a single axis to separate treatment responders from treatment non-responders (or to separate all groups of treat responders, treatment non-responders, placebo responders and placebo non-responders) can produce superior results to utilizing the standard cordance methods, with lower cross validation error and re-substitution error rates (thus improving the robustness of the methodology).

6). In addition, work has been done to demonstrate that best results for practical prediction of treatment response may include pharamcogenomic (or pharmacoproteomic) data, in addition to any imaging and/or QEEG data. That is because, even though the methods below may provide models to accurately predict response, in practicality, pharamcogenomic effects may preclude the effectiveness of the actual use of the medication. For example, pharmacokinetic genomic effects (including, but not limited to, genes that affect absorption, distribution, metabolism and excretion of the drug) may significantly affect treatment response. If an individual has genes that greatly speed specific drug metabolism, then at standard doses, the concentration may never get high enough to produce treatment response. Conversely, if the individual has genes that lead to very slow drug metabolism, then the concentration in the blood may be too high when using standard doses, and side effects, adverse reactions, and toxicity could develop. Likewise, pharamcodynamic genomic effects could lead to poor activity of the medication at desired sites of action in the body, so that there is poor treatment response. Conversely, pharamcodynamic genomic effects might lead to increased and too high activity at desired sites of action, producing side effects, adverse effects and toxicity. Therefore, results of pharmacogenomic analysis, in addition to imaging/QEEG and other analysis, can provide for the best practical clinical models to determine treatment response.

Analysis of new data shows that combination of QEEG analysis methods plus pharamcogenomics data improves clinical utility of results for psychiatric, neurologic and other applications, including specifically, but not limited to, antidepressant medication use and antipsychotic medication use.

Empirical findings here confirmed the conclusion of prior researchers: that ensemble generally outperforms component classifiers; and that ensembles are more robust over multiple data sets.

Weighted-Factor CART Models

Weighted-factor variables, analysis where weighted-factor variables were created as linear combinations of absolute and relative powers. The inventors labeled these variables with designators “z0”, “z2”, “z4”, etc. where “z0” are equivalent to relative powers and “z1” to absolute powers. This confirmed our previous analysis—via t-tests—that absolute powers did not provide as much help in differentiating responders from non-responders.

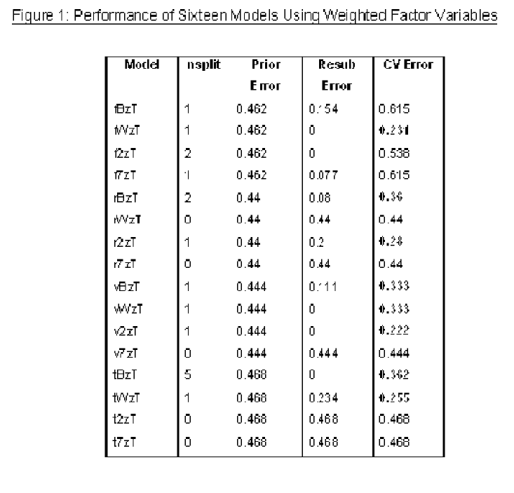

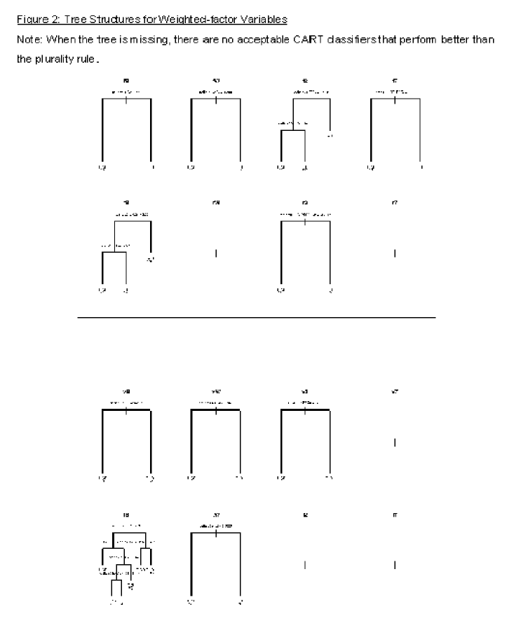

Eight good models with less than 40% cross-validation error were found (FIG. 1). The 16 models include fb, fw, f2, f7, rb, rw, r2, r7, vb, vw, v2, v7, tb, tw, t2, t7, where “t7”, for instance, represents all drugs, 7-day data. In fact, only two of these models (fW, tB) used a weighted factor as the primary split; all the others used relative powers. (FIG. 2). Cross-validation error is an estimate of the true prediction error; resubstitution error is the error rate of classifying the training set; prior error is the error using the plurality rule i.e. classify every patient as a responder if there are more responders in the sample and vice versa. A model with error worse than prior rate is worthless.

Further Analysis of PCA Models

1) The inventors had previously found nine PCA models (16 models include fb, fw, f2, f7, rb, rw, r2, r7, vb, vw, v2, v7, tb, tw, t2, t7, where “t7”, for instance, represents all drugs, 7-day data) with less than 40% cross-validation error. The cross-validation error is an estimate of the true prediction error; resubstitution error is the error rate of classifying the training set; prior error is the error using the plurality rule i.e. classify every patient as a responder if there are more responders in the sample and vice versa. A model with error worse than prior rate is worthless.

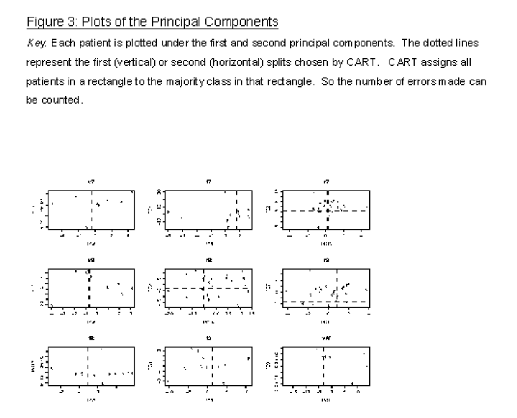

The results with PCA are shown in FIG. 3.

2) In FIG. 3, data are plotted on the two variables that account for most of the variation. These are identified as the first and second principal components (PC).

3) CART models effectively carve up the space into rectangles depending on the number of splits. Each rectangle is assigned to a class (T-R or T-NR). The plots indicate that for each of these nine good PCA models, CART makes no more than two errors on the training set.

Principal Components Analysis (PCA)

PCA is a standard statistical technique primarily used for reducing the dimension of multivariate data. It is easiest to understand PCA through geometry. Each sample in the data can be visualized as a point in a geometric space with axes representing the variables. PCA finds a new set of axes by rotating to the direction of maximum variance and then picking further axes perpendicular to the previous ones. The new axes are respectively called first, second . . . principal components. Because the variance of a small number of principal components often accounts for most of the variance in the original data, statisticians have used PCA for dimension reduction.

Another property of principal components is that they are linear combinations of the original variables (equivalently, the inventors can say the new axes are rotations of the original axes).

The interest in PCA comes from both these properties. By using principal component variables instead of the original variables, the inventors addressed two of the weaknesses of tree-based classification, namely, its tendency to get distracted by redundant or irrelevant variables, and its inability to look for multi-dimensional splits.

The second point may require further elucidation. CART continues to look for univariate splits but these splits are now occurring under the new set of axes and since these axes are linear combinations of the original axes, each univariate split under the new axes represents a multidimensional split under the original axes.

By combining PCA and CART, the inventors discovered nine useful models which made fewer than 2 errors in the training sets while also attaining sufficiently low cross-validation errors.

CART Models Using Relative Powers Only

1) Eight out of 16 models committed less than 40% cross-validation error. Of these, 4 of them correctly classified every patient in the training sets. Plurality rule i.e. classify every patient as a responder if there are more responders in the sample and vice versa. A model with error worse than prior rate is worthless.

2) Three more models had zero training-set error, making a total of 7. These three had cross-validation errors over 40%, meaning that their performance is unlikely to be generalized.

3) Venlafaxine models in particular performed well, achieving 11-33% cross-validation errors with just one split each. The fluoxetine relative models were not as useful.

4) Comparison of R (relative only) models with ARZ (absolute/relative/Z cordance) models:

a) The inventors found 8 good relative-power (R) models compared to 6 good ARZ models.

b) It appeared that R models were particularly good for venlafaxine and “all drugs” problems. By contrast, ARZ models were useless for venlafaxine and “all drugs”. Thus, the results were complementary.

c) The resubstitution errors of R models were better than the prior error (plurality rule) in all but one model. However, no satisfactory models were found for venlafaxine and “all drugs” models except one.

d) Of note, the R model for all drugs at wash-in was satisfactory (26% cross-validation error; 23% resubstitution error).

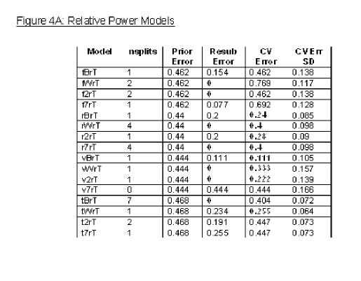

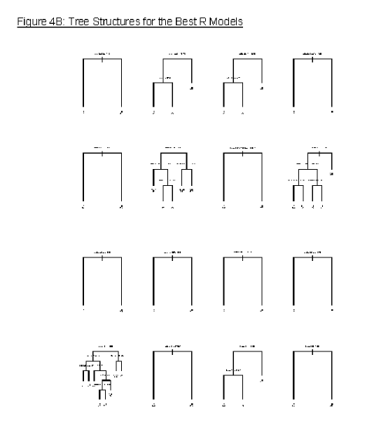

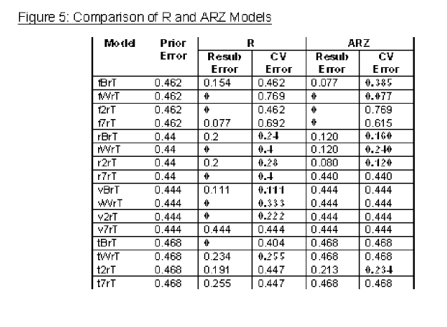

FIG. 4 displays the relative power models. FIG. 5 shows the comparison of R and ARZ Models

### Example 3

The Analysis of Regional Data for Placebos

1. Preliminaries

(a) The inventors examined 15 models, namely fP, fbP, fwP, f2P, f7P; vP, vbP, vwP, v2P, v7P; tP, tbP, twP, t2P, t7P. “P” designates placebo as “T” stood for treatment previously. The other definitions are as before.

(b) For fluoxetine, there were 10 patients (5 P-R, 5-P-NR); for venlafaxine, there were 12 patients (2 P-R, 10 P-NR); for all (both) drugs, there were 22 patients (7 P-R, 15 P-NR). There is no placebo data for reboxetine.

2. CART Analysis (ARZ)

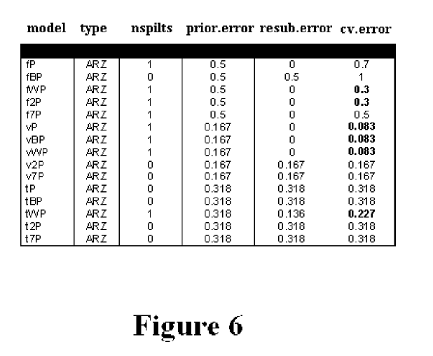

(a) As shown in FIG. 6, CART alone with ARZ data did not perform well in classifying the placebo patients. For 7 out of 15 models, CART could not discover a tree classifier that could outperform the plurality rule.

(b) Of the good models, there were 6 which met the 40% cross-validation threshold. All of these contained one split.

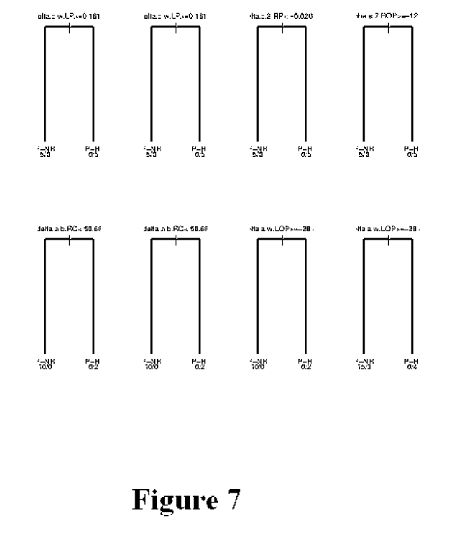

(c) The splitting variables and values can be read off from the graph in FIG. 7.

3. Ensemble Analysis

(a) The inventors formed an ensemble (panel) of one-level CART trees by picking the three regions that proved most predictive, namely ROP, RP and Fplus. These three regional experts then vote by majority to classify patients; no tie-breaking is necessary due to the odd number of component trees.

(b) The ensemble found remarkably good models. 14 out of 15 models passed the 40% threshold for cross-validation error.

(c) The boxplots showed that the ensemble performed very well in terms of resubstitution errors. In addition, the ensemble had clearly smaller variance than individual tree classifiers.

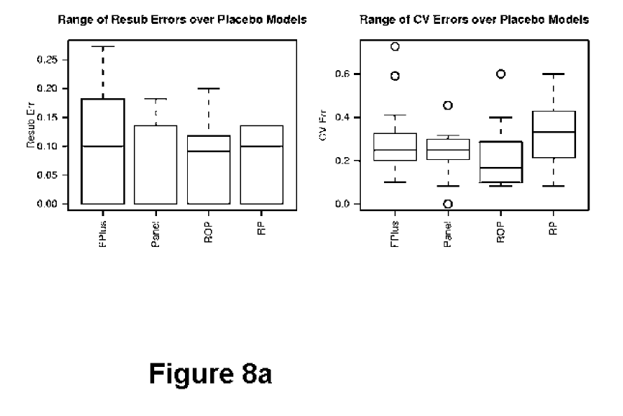

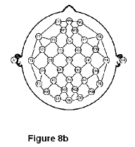

(d) For the current data set, the regional expert “ROP” appeared to have superior cross-validation error compared to the ensemble. This result may or may not be generalizable, because the variance is much higher. As shown in FIG. 8a, the top and bottom of each box are roughly 25^{th} and 75^{th} percentiles; the line in the middle of each box is the median. The “whiskers” go out to extremes. The dots represent outliers.

4. All of our Placebo models ranked by CV error are in Table 1 below.

| Model | Type | Resub. Err | CV. Err |
|---|---|---|---|
| fwP | Panel | 0 | 0 |
| vP | ROP | 0 | 0.083 |
| vP | RP | 0 | 0.083 |
| vP | Panel | 0 | 0.083 |
| vbP | ROP | 0 | 0.083 |
| vbP | RP | 0 | 0.083 |
| vbP | Panel | 0 | 0.083 |
| vWP | ROP | 0 | 0.083 |
| vP | ARZ | 0 | 0.083 |
| vBP | ARZ | 0 | 0.083 |
| vWP | ARZ | 0 | 0.083 |
| fwP | ROP | 0.1 | 0.1 |
| fwP | FPlus | 0 | 0.1 |
| F7P | ROP | 0 | 0.1 |
| twP | ROP | 0.13 | 0.136 |
| T7P | ROP | 0.091 | 0.136 |
| vP | FPlus | 0 | 0.167 |
| vbP | FPlus | 0 | 0.167 |
| v2P | RP | 0 | 0.167 |
| v7P | ROP | 0 | 0.167 |
| v2P | ARZ | 0.167 | 0.167 |
| v7P | ARZ | 0.167 | 0.167 |
| tbP | ROP | 0.136 | 0.182 |
| T2P | ROP | 0.136 | 0.182 |
| T2P | Panel | 0.136 | 0.182 |
| fP | FPlus | 0 | 0.2 |
| fbP | FPlus | 0.1 | 0.2 |
| F2P | RP | 0 | 0.2 |
| F2P | FPlus | 0.1 | 0.2 |
| twP | RP | 0.136 | 0.227 |
| twP | Panel | 0.182 | 0.227 |
| T2P | RP | 0.136 | 0.227 |
| T7P | Panel | 0.136 | 0.227 |
| tWP | ARZ | 0.136 | 0.227 |
| vwP | FPlus | 0 | 0.25 |
| vwP | Panel | 0 | 0.25 |
| v2P | Panel | 0 | 0.25 |
| v7P | FPlus | 0.083 | 0.25 |
| v7P | Panel | 0 | 0.25 |
| tP | ROP | 0.091 | 0.273 |
| T7P | RP | 0.136 | 0.273 |
| fP | ROP | 0 | 0.3 |
| fP | Panel | 0 | 0.3 |
| fbP | Panel | 0.1 | 0.3 |
| F2P | Panel | 0 | 0.3 |
| F7P | FPlus | 0.1 | 0.3 |
| F7P | Panel | 0 | 0.3 |
| fWP | ARZ | 0 | 0.3 |
| F2P | ARZ | 0 | 0.3 |
| tbP | Panel | 0.136 | 0.318 |
| T2P | FPlus | 0.182 | 0.318 |
| T7P | FPlus | 0.182 | 0.318 |
| tP | ARZ | 0.318 | 0.318 |
| tBP | ARZ | 0.318 | 0.318 |
| T2P | ARZ | 0.318 | 0.318 |
| T7P | ARZ | 0.318 | 0.318 |
| vwP | RP | 0.083 | 0.333 |
| v2P | ROP | 0.083 | 0.333 |
| v2P | FPlus | 0.083 | 0.333 |
| fP | RP | 0 | 0.4 |
| fbP | ROP | 0.1 | 0.4 |
| fwP | RP | 0.1 | 0.4 |
| F7P | RP | 0.1 | 0.4 |

Includes only models meeting 40% threshold

When type is a region, the tree classifier is a component of the panel.

TABLE 2

Tree Classification of Patients on Anti-Depressants

| Model | Type | Prior Error | Resub Error | CV Error |
|---|---|---|---|---|
| v7T | PCA | 0.444 | 0 | 0 |
| fWT | ARZ | 0.462 | 0 | 0.07 |
| vBT | Relative | 0.444 | 0.111 | 0.111 |
| r2T | ARZ | 0.44 | 0.08 | 0.12 |
| f7T | PCA | 0.462 | 0.077 | 0.154 |
| rBT | ARZ | 0.44 | 0.12 | 0.16 |
| r7T | PCA | 0.44 | 0 | 0.16 |
| r2T | Small | 0.44 | 0.08 | 0.16 |
| | Panel | | | |
| t7T | Small | 0.468 | 0.13 | 0.191 |
| | Panel | | | |
| v2T | Relative | 0.444 | 0 | 0.222 |
| vBT | PCA | 0.444 | 0 | 0.222 |
| vBT | Full Panel | 0.444 | 0.11 | 0.222 |
| vBT | Small | 0.444 | 0 | 0.222 |
| | Panel | | | |
| vWT | Small | 0.444 | 0 | 0.222 |
| | Panel | | | |
| v2T | Small | 0.444 | 0 | 0.222 |
| | Panel | | | |
| fWT | WF | 0.462 | 0 | 0.231 |
| t2T | ARZ | 0.468 | 0.213 | 0.234 |
| rBT | Relative | 0.44 | 0.2 | 0.24 |
| rWT | ARZ | 0.44 | 0.12 | 0.24 |
| tWT | Relative | 0.468 | 0.234 | 0.255 |
| r2T | Relative | 0.44 | 0.2 | 0.28 |
| rBT | PCA | 0.44 | 0.08 | 0.28 |
| r2T | PCA | 0.44 | 0.08 | 0.28 |
| fBT | PCA | 0.462 | 0.154 | 0.308 |
| f2T | PCA | 0.462 | 0.154 | 0.308 |
| fWT | Small | 0.462 | 0 | 0.308 |
| | Panel | | | |
| vWT | Relative | 0.444 | 0 | 0.333 |
| vWT | PCA | 0.444 | 0.111 | 0.333 |
| vWT | Full Panel | 0.444 | 0 | 0.333 |
| t2T | Small | 0.468 | 0.21 | 0.34 |
| | Panel | | | |
| tBT | WF | 0.468 | 0 | 0.362 |
| tBT | Full Panel | 0.468 | 0.28 | 0.383 |
| t2T | Full Panel | 0.468 | 0.11 | 0.383 |
| t7T | Full Panel | 0.468 | 0.21 | 0.383 |
| fBT | ARZ | 0.462 | 0.077 | 0.385 |
| fBT | Small | 0.462 | 0.15 | 0.385 |
| | Panel | | | |
| rWT | Relative | 0.44 | 0 | 0.4 |
| r7T | Relative | 0.44 | 0 | 0.4 |
| rBT | Small | 0.44 | 0.08 | 0.4 |
| | Panel | | | |

### Example 4

Use of Single Point Cart Analysis (Placebo or Treatment):

CART analysis using single point placebo data produced some effective models, but the results were more unstable than regional or ensemble results. In CART single point analysis, Z scores were more predictive than the absolute scores. None of the relative scores were chosen in CART or logistic models utilizing single point data.

While single electrode placebo analysis provided very significant results, such as utilizing placebo data from AF1, AF2, C3, C4, T4, CP1, CP2, CP5 and CP6 for some of the best models (but also utilizing some other single points in other significant models) at baseline and/or change from baseline to wash-in (i.e. from before treatment to the end of 1 week of single (i.e. patient) blind placebo treatment) an/or wash-in data (at the end of 1 week of single (i.e. patient) blind placebo treatment), with change from baseline to wash-in being found in this particular example to in general be most effective when using single electrode analysis), in predicting which individuals would be placebo responders vs. non-responders, the re-substitution and cross-validation rates were considered unacceptable, at least as compared to results with the use of ensemble methodology (whether using single point or regional analysis) or other regional methodology (i.e. PCA, relative data, etc.).

CART analysis using single point treatment wash-in (de-facto placebo) data produced some effective models, but results were more unstable than regional or ensemble results. While single electrode analysis provided very significant results, such as utilizing treatment data from C3, C4, P4, CP1, CP2, CP5, CP6, FP1, PO2, AF1 and AF2 for some of the best models (but also utilizing some other single points in other significant models) at baseline and/or change from baseline to wash-in and/or wash-in data (with change from baseline to wash-in being found in this particular example to in general be most effective when using single electrode analysis), in predicting which individuals would be treatment responders vs. non-responders, the re-substitution and cross-validation rates were considered unacceptable, at least as compared to results with the use of ensemble methodology (whether using single point or regional analysis) or other regional methodology (i.e. PCA, relative data, etc.).

In regards to frequency range used in models using single point treatment data, all bands provided useful data, at least in specific models for specific drugs, with theta and then beta frequency being most productively used in the single point CART models (but with use of delta and alpha frequency ranges useful in some significant models). Of interest, for models using single point placebo data, delta and alpha frequency ranges were most productive (but theta and beta frequency ranges useful in some significant, but less significant, models).

CART analysis using single point placebo ensemble data were the most stable for the analyses of single point placebo data, and some models approached the stability of regional ensemble results, with some models of equal stability. These results, in general were more stable than results with placebo single point data and single point treatment wash-in data (lower re-substitution and cross-validation error levels), but in general were not as stable as those obtained with use of regional data. CART analysis using single point data produced some effective models, but they were less stable than regional data results in general, although some of the ensemble results were of equal stability.

In general, while results with single point data were statistically significant, the results were not as significant as CART results, and required use of later in time data, that being 2 and 7 day data. The best CART methodology model results had significantly lower variance than single point statistical results.

Importance and Usefulness of Combination of QEEG Results with Pharmacogenomic and/or Pharmacoproteomic Data:

These results can be of significant use and value (CART placebo data analysis and treatment data analysis methods) to the pharmaceutical industry to eliminate those who will not response to treatment from pharmaceutical studies. When used in conjunction with pharmacoogenomic and/or pharmacoproteomic data, elimination of likely non-responders from clinical trials, or actual treatment, lead to more successful studies and less treatment failures.

Cordance Calculations (as Previously Described by Leuchter and Cook in their Articles and Pranted Patents).

For each recording site in each of the four bands (delta, theta, alpha, beta), cordance values were calculated using an algorithm that has been detailed elsewhere (Leuchter et al., 1999) and may be summarized as follows. Cordance is computed by a normalization and integration of absolute and relative power values from all electrode sites for a given EEG recording; cordance values are calculated in three steps. First, EEG power values are computed using a re-attributional electrode montage in which power values from pairs of electrodes that share a common electrode are averaged together to yield the re-attributed power as shown in FIG. 8b (Cook et al., 1998b). For example, to determine a power value for the brain region underlying the F4 electrode, one first computes power spectra for the channels that include the F4 electrode (i.e., F4-F8, F4-AF2, F4-FC2, and F4-FC6), and then averages the absolute power values from those channels to obtain the reattributed power for the F4 electrode. This is somewhat similar to the single source method of Hjorth (1970, 1975), but cordance recombines the power values whereas Hjorth's method recombines voltage signals by averaging signal amplitudes from pairs of electrodes. The Hjorth method is preferred under many experimental designs, particularly when the source of a signal is the question of interest (e.g., seizure focus); the re-attributional montage provides a higher association between QEEG measures and regional cortical perfusion than does the Hjorth method (Cook et al., 1998b) and so offers an advantage for testing our specific hypotheses. Relative power is calculated in the conventional manner, as the percentage of power in each band, relative to the total spectrum considered (0.5 Hz to 20 Hz) (cf. Leuchter et al., 1993).

Second, these absolute and relative power values for each individual EEG recording are normalized across electrode sites, using a z-transformation statistic for each electrode site s in each frequency band f (yielding Anorm(s,f) and Rnorm(s,f) respectively). It should be noted that these z-scores are based on the average power in each band for all electrodes within a given QEEG recording, and are not z-scores referenced to some normative population (e.g., as in the “neurometrics” approach). The normalization process places absolute and relative power values into a common unit (standard deviation or z-score units) which allows them to be combined.

Third, the cordance values are formed by summing the z-scores for normalized absolute and relative power (Z(s,f)=Anorm(s,f)+Rnorm(s,f), for each electrode site and in each frequency band). Cordance values have been shown to have higher correlations with regional cerebral blood flow than absolute or relative power alone (Leuchter et al., 1999), and thus this combination measure can be placed in context with prior work in depression that employed functional measures of brain activity such as PET scan data.

Cordance was calculated by combining conventional QEEG absolute and relative power measures in a common metric, and was computed in three steps using methods the inventor have detailed previously (Leuchter 1997, 1999) and describe briefly here. First, EEG power values were computed using a re-attributional electrode montage because that montage afforded the highest correlation between EEG measures and PET measures of rCBF. Second, these values were normalized across all electrode sites using a z-transformation, yielding Anorm(s,f) & Rnorm(s,f) for all sites s and frequency bands f. Third, cordance values were formed as the sum of Anorm and Rnorm.
Z(s,f)=Anorm(s,f)+Rnorm(s,f)

The Classifying Responders into Drug Groups Using Baseline Predictors

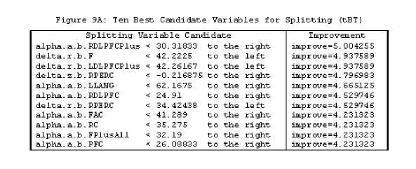

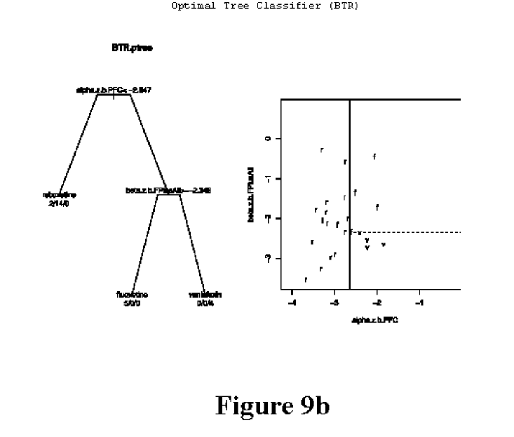

The optimal tree classifier is shown in FIG. 9B. It is equivalent to these simple rules:

| Classify as: | If: |
|---|---|
| Fluoxetine | alpha.z.b.PFG>=−2.647 AND beta.z.b.FPlusAll>=−2.348 |
| Reboxetine | alpha.z.b.PFG< −2.647 |
| Venlafaxin | alpha.z.b.PFG>=−2.647 AND beta.z.b.FPlusAll< −2.348 |

Classifying Patients of Each Drug Group into Responder/Non-Responder using DRUG and Baseline Predictors

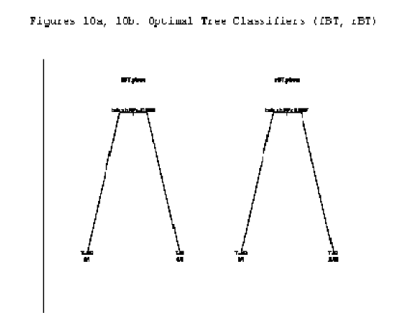

FIGS. 10a, 10b show the optimal tree classifiers found for fluoxetine and reboxetine patients. These models had cross-validation errors of 38.5% and 16%; and re-substitution errors of 7.7% and 12% respectively. In particular, model rBT appeared to be potentially useful. It may be possible to use baseline brainwave data alone to predict whether patients will or will not respond to reboxetine.

A satisfactory model for reboxetine patients, but no useful model for all patients, suggested that baseline differentiable models exist.

In FIGS. 10a, 10b models fBT and rBT both involved beta.z.b.RPas the splitting variable.

Other Predictive Models

Tree classifiers that use brainwave data at wash-in, 2-day and 7-day were sought. Using a generous cut-off of 40% cross-validation error, six tree classifiers to be relatively effective were identified. The best-performing of these misclassified only 7.7% of the cross-validation sample, or 92.3% accuracy.

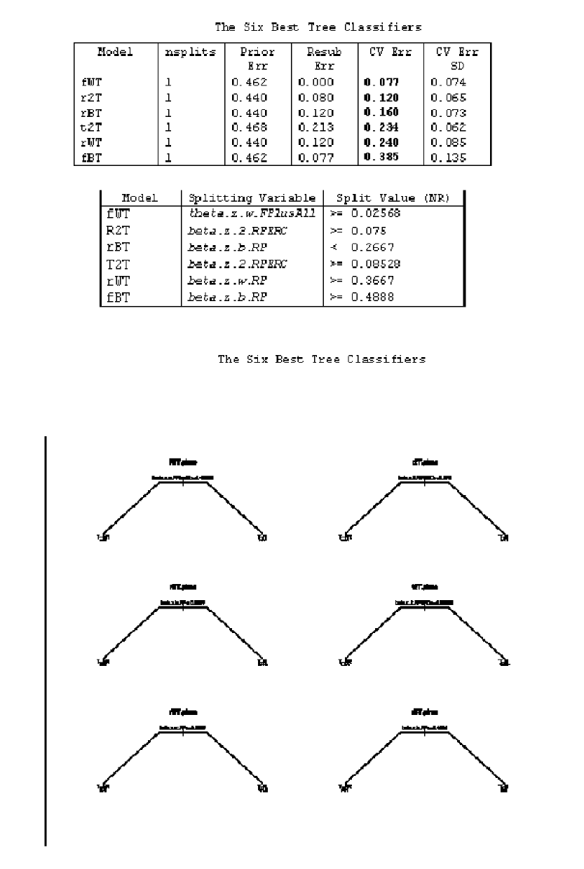

The attributes of these models and those above are given in FIG. 11. Reboxetine models were the most satisfactory. All six splitting variables involved z-score, and all except fWT used beta measurements.

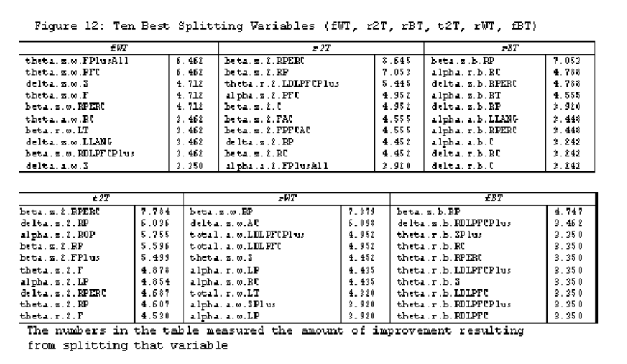

These classifiers are presented graphically in FIG. 11. FIG. 12, gives the 10 best splitting variables for each of the six good models.

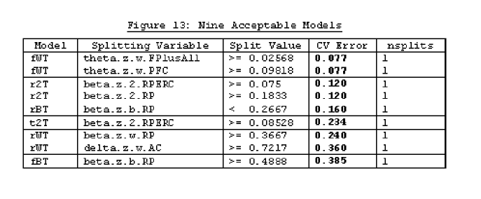

“Second-best” models with cross-validation errors under 40%. In each of 54 cases, the best splitting variable was removed from consideration, thus forcing the algorithm to split the data using successively lower-ranked variables. The entire universe of nine (9) acceptable models are presented in FIG. 13.

The following several sections provide details of the analyses described here.

Predictive Models for Wash-in

Models that use wash-in brainwave data to predict response. As with above, reasonable tree classifiers were found for fluoxetine and reboxetine patients.

In particular, model fWT performed superbly, classifying all patients correctly in the training set and achieving 7.7% misclassification in cross validation (FIG. 11).

Model rWT also merits further investigation as it made a cross-validation error of 24%.

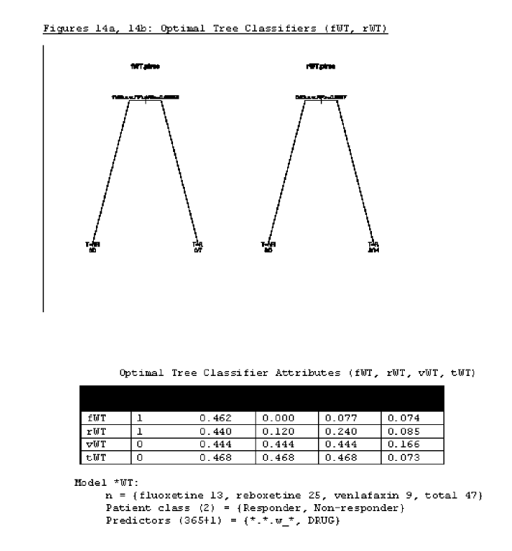

These classifiers are shown graphically in FIGS. 14a, 14b. The variables most effective in splitting the training sets were theta.z.w.FPlusAll for model fWT and beta.z.w.RP for model rWT.

Predictive Models for 2-Day

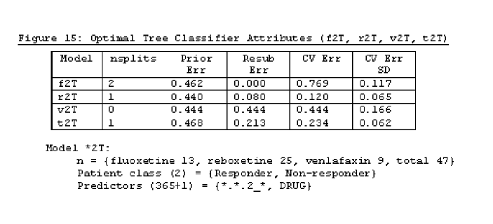

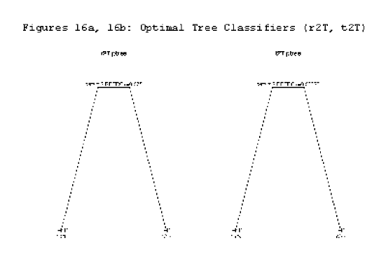

Classifiers using 2-day brainwave data to predict response. As summarized in FIG. 15, model r2T was promising, yielding cross-validation error of 12% and re-substitution error of 8%. Model t2T was second best with cross-validation error of 23.4%. These models are displayed in FIGS. 16a, 16b. They both used beta.z.2.RPERC as a splitting variable.

Effect of Time of Measurement

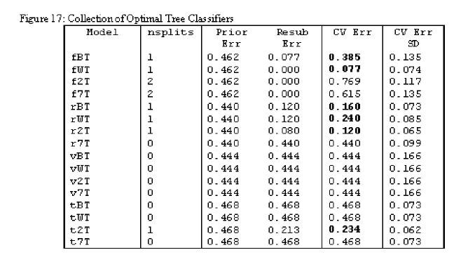

As an aside, classifying all patients (models txT) was more difficult than classifying patients of a specific DRUG group. This indicated that a DRUG effect was present. FIG. 17 shows a collection of optimal tree classifiers.

A collection of nine tree classifiers for the data were discovered, with cross-validation misclassification errors ranging from 7.7% to 38.5%. The characteristics of these models are listed above. Using baseline, wash-in, 2-day or 7-day brainwave data, these models classify patients into responders vs. non-responders. The collection of nine consisted of six “best” models and three “second-best” models (whose performance would be dominated by the “best” models).

All but one of these models found structure in the training set when restricted to a specific DRUG class, indicating that a DRUG effect was present. In particular, the presence of a good baseline model for reboxetine patients and the absence of such for all patients provided preliminary evidence that baseline differentiable models exist.

Tree models were found which classifies responders into fluoxetine vs. reboxetine vs. venlafaxine, using baseline brainwave data, with acceptable cross-validation error. This suggested that the drugs may have differentiable effects on brainwave patterns.

### Example 5

The Tree Classification of Patients on Anti-Depressants: Extensions 1: T-Tests

Most variables were found unhelpful in separating patients into Responder/Non-Responder groups, in the sense that t-tests for equal group means were insignificant at 95% confidence level. The useful variables, known as “95% variables”, were analyzed: most were cordance measures; some were relative powers and few were absolute powers (only for reboxetine). In addition, they came from a wide range of brain regions. In terms of measurement times, the inventors observed a pattern of 7>w>2>b in most cases.

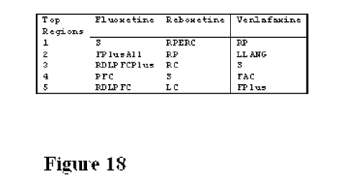

The FIG. 18 lists the top regions according to how many 95% variables were found.

Detailed Results of Using T-Tests to Separate Patients into Responder/Non-Responder Groups

Methodology

(i) Procedure: For each variable, the inventors compared the group variances (using the F test) and then the group means (using the t-test). The Welch t-test was applied if variances were not equal.

(ii) t-test For each variable, the t-test addresses whether the mean of the Responder group is different from the mean of the Non-Responder group.

(iii) Significance Level: The inventors identify as “95% variables” those variables with statistically different group means at the 95% confidence level (i.e. p-value<=0.05).

(iv) Tabulations: Next, the inventors analyzed the types of 95% variables, including brain regions, time of measurement, frequency band and metric (i.e. absolute power, relative power or z-score). In judging the relative importance of a particular factor level such as z-score, the inventors used the number of 95% variables of this type.

(v) Steps (i)-(iv) were repeated for each drug.

With Fluoxetine

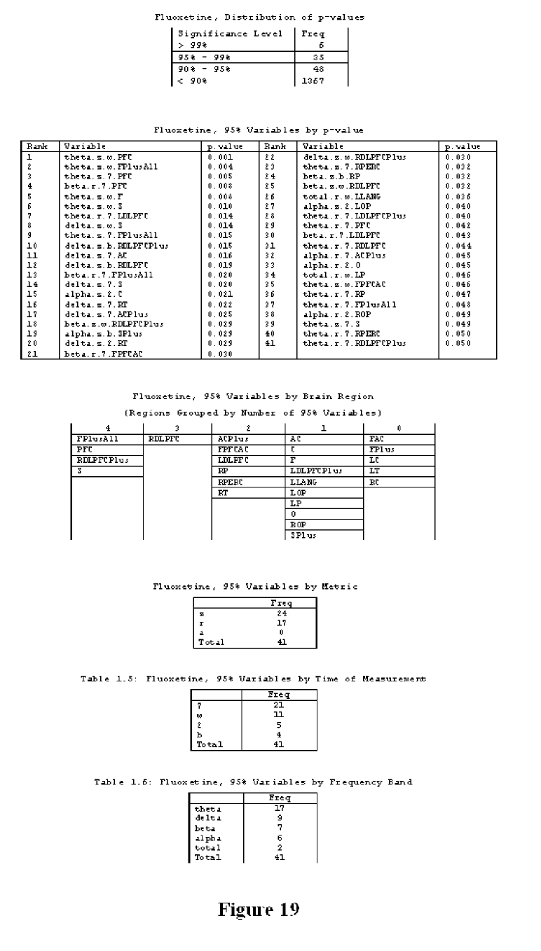

(i) As shown in FIG. 19, Out of 1456 variables, there were 41 “95% variables”.

(ii) The 95% variables are shown in FIG. 19.

(iii) Tabulation by brain region: Each region provided 0-4 95% variables; five regions (RC, LC, FAC, FPlus, LT) had none. In particular, numerous combination regions appeared at the top of the list.

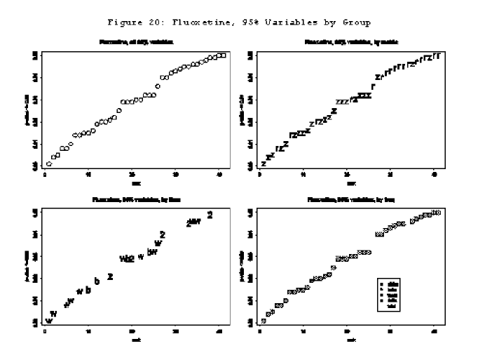

(iv) Tabulation by metric: most of the 95% variables were z-scores while none were absolute powers. Further, FIG. 20 shows that z-scores generally held higher ranks than relative powers in terms of level of significance.

(v) Tabulation by time of measurement: in terms of number of 95% variables, a trend of 7>w>(2,b) was observed. See also FIG. 20.

(vi) Tabulation by frequency band: the theta band contributed the most 95% variables. See also FIG. 20.

(vii) FIGS. 19 and 20 summarizes the analyses of (iv)-(vi).

With Reboxetine

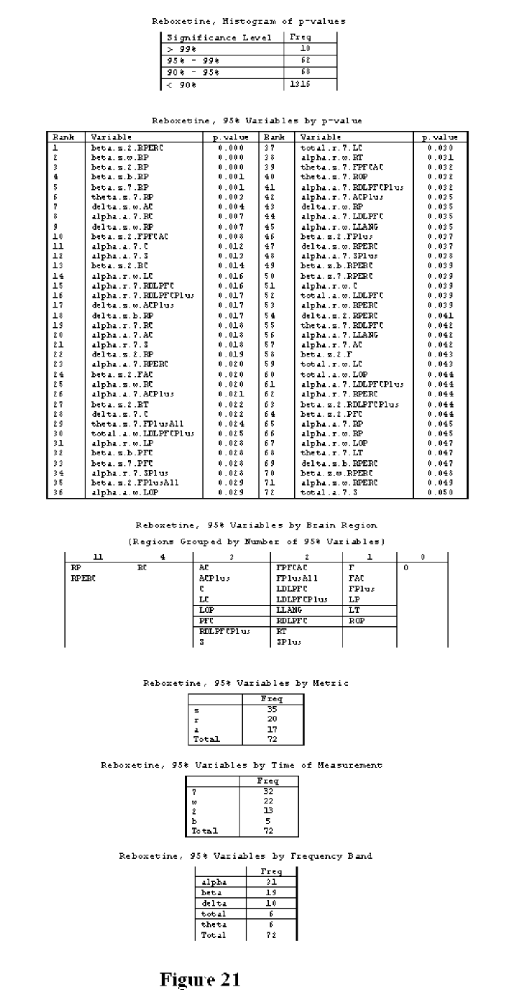

(i) As shown in FIG. 21, 72 of 1456 variables with significantly different means between Responder and Non-Responder groups at the 95% confidence level.

(ii) The 95% variables are shown in FIG. 21.

(iii) Tabulation by brain region: the 95% variables came from 25 different regions but especially RPERC and RP.

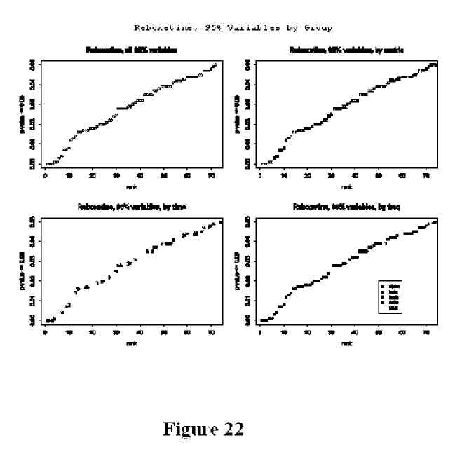

(iv) Tabulation by metric: most of the 95% variables were z-scores although relative and absolute powers both contributed. Further, FIGS. 21 and 22 show that z-scores generally held higher ranks than relative powers in terms of level of significance.

(v) Tabulation by time of measurement: 7-day variables were most useful; baseline variables, least useful. See also FIGS. 21 and 22.

(vi) Tabulation by frequency band: the alpha and beta bands contributed the most 95% variables. See also FIGS. 21 and 22.

(vii) FIG. 22 summarizes the analyses of (iv)-(vi).

With Venlafaxine

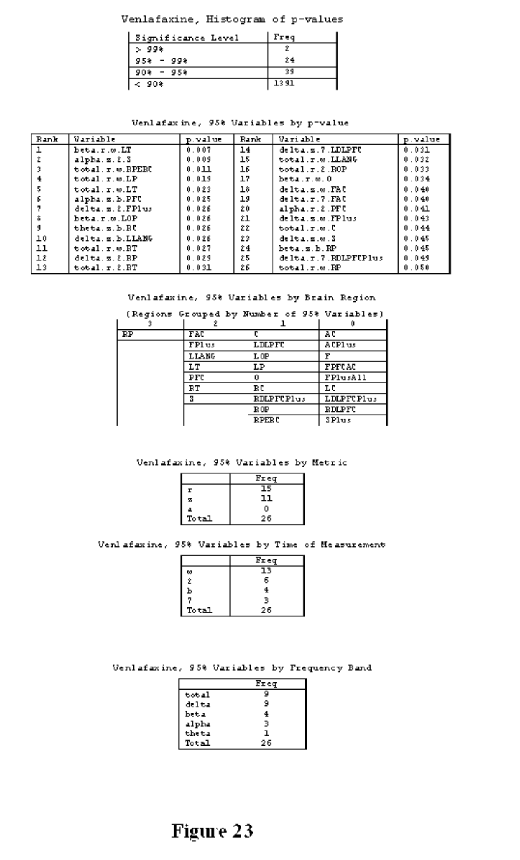

(i) As shown in FIG. 23, 26 of 1456 variables with significantly different means between Responder and Non-Responder groups at the 95% confidence level.

(ii) The 95% variables are shown in FIG. 23:

(iii) Tabulation by brain region: the 95% variables came from 17 different regions.

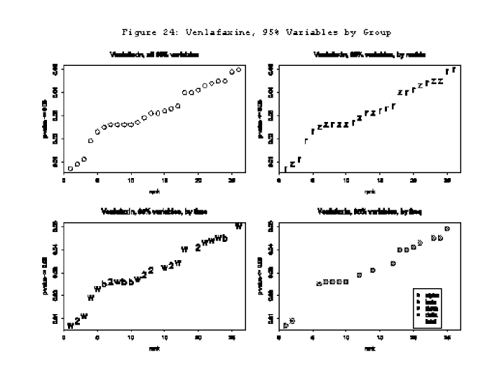

(iv) Tabulation by metric: most of the 95% variables were relative powers, followed by z-scores while none were absolute powers. See also FIG. 24.

(v) Tabulation by time of measurement: the wash-in data provided the most 95% variables. See also FIG. 24.

(vi) Tabulation by frequency band the total and delta bands contributed the most 95% variables. See also FIG. 24.

(vii) FIG. 24 summarizes the analyses of (iv)-(vi).

PCA Analysis

The inventors concluded that simple, linear functions are inadequate to use as variables for response models, based on a preliminary investigation using t-tests. In this work, the inventors explored linear combinations of absolute and relative powers, weighted by factors wf and (1−wf) as wf ranged from 0 to 1. In comparing one level of wf against another, the inventors used the measure of the number of 95% variables created.

For fluoxetine and venlafaxine, no absolute powers were 95% variables. In these cases, the inventors found that relative powers provided upper bounds to the number of 95% variables. Since relative powers typically under-perform z-scores, the inventors did not find a simple linear combination of relative and absolute powers that can outperform z-scores.

For reboxetine, some absolute powers were 95% variables. At each level of the weighting factor, the inventors generated about the same number of 95% variables.

PCA models using relative powers by themselves can generate CART models competitive with cordance. In addition, competitive CART models can be built using weighted-factor variables for reboxetine. Competitive is defined as having cross-validation errors comparable to cordance-based models.

A Summary of (PCA)

PCA is used to generate new variables which are particular linear combinations of absolute and relative powers. Using these PCA variables, the inventors found 9 additional baseline differentiable models exceeding our threshold cross-validation error rate of 40%.

### Example 6

Weighting Factor Problem

The Rationale:

Leuchter and associates developed “cordance” as a metric for cortical disaffectation. Cordance is a non-linear function of absolute and relative powers. In this section, the inventors attempted to find a simple, linear function involving absolute and relative powers that have better predictive power than cordance.

The Methodology:

(i) t-tests: The inventors repeated the work above using a new set of variables indexed by weighting factor wf. The new variables are defined by z.wf(s,f,t)=wf*a(s,f,t)+(1−wf)*r(s,f,t), where s=brain region, f=frequency band, t=time of measurement, a=absolute power, r=relative power.

(ii) Weighting factor variables: In the weighting factor problem, each level of wf leads to 520 new variables (indexed by site, frequency and measurement time). The inventors let wf=0, 0.2, 0.4, 0.6, 0.8.1; and labelled the variables z0, z2, z4, z6, z8, z1 respectively. In particular, z0, z1 reproduced the relative and absolute powers.

(iii) Weighting factor problem: The relative value of wf was given by the total number of 95% variables thus generated. The inventors sought the best value of wf.

The Results:

Fluoxetine, New Variables

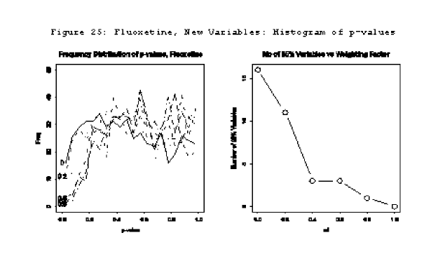

(i) Of the 520*4=2080 new variables (of the type z.wf), only 18 attained 95% confidence. FIG. 25 (derived from histograms) shows that the number of 95% variables decreased as wf increased, leading us to conclude that 0<=wf <=0.2 is the region of interest.

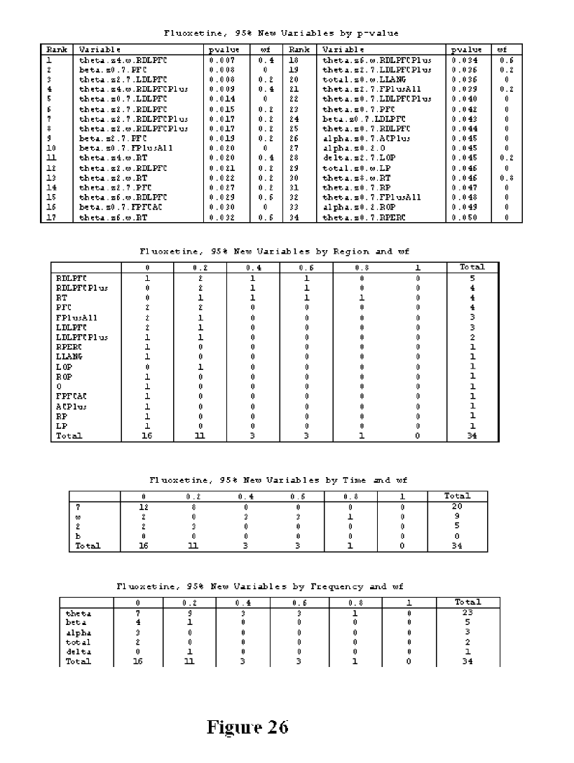

(ii) The 95% variables were these: 16 of these 34 variables were strictly relative powers (wf=0). As shown in FIG. 26, the new 95% variables had generally lower p-values.

(iii) Tabulation by brain region: 16 regions contributed 95% variables. With relative powers (wf≈0) removed, 8 regions contributed. Combination regions rose to the top of the list. Comparing columns for wf=0 and wf=0.2 indicated that combining variables had different impacts in different regions.

(iv) Tabulation by time of measurement: the 7>w>2 trend was observed while baseline variables did not reach 95% confidence at any level of wf.

(v) Tabulation by frequency band: at all levels of wf, theta variables proved most useful. wf=0.2 produced similar numbers of 95% variables as wf=0 (relative power).

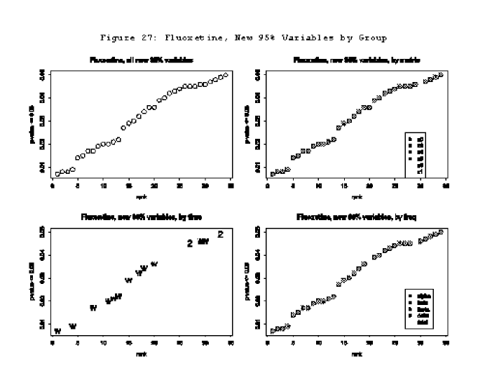

(vi) FIG. 27 summarizes the discussion in (ii), (iv), (v).

Reboxetine, New Variables

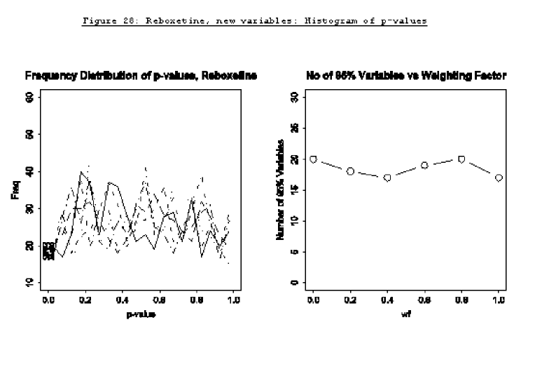

(i) Of the 2080 new variables (of the type z.wf), 115 attained 95% confidence; of these, 37 were absolute or relative powers. FIG. 28 showed, further, that the number of 95% variables remained relatively constant regardless of wf.

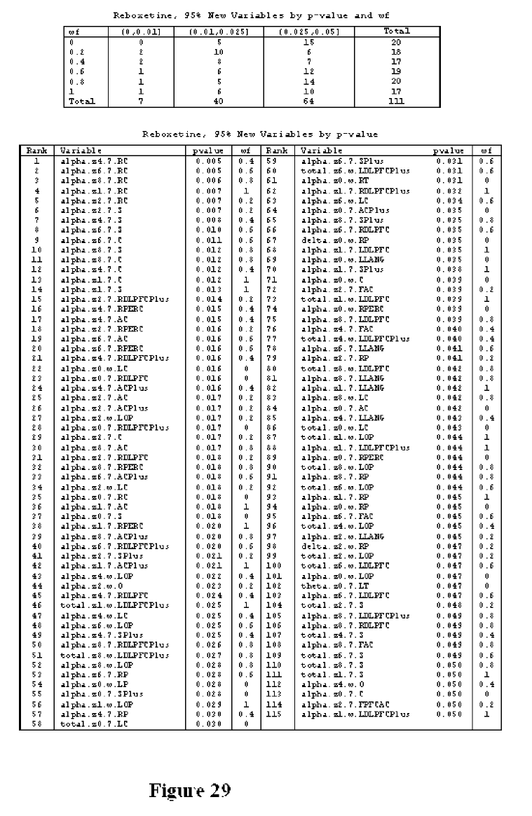

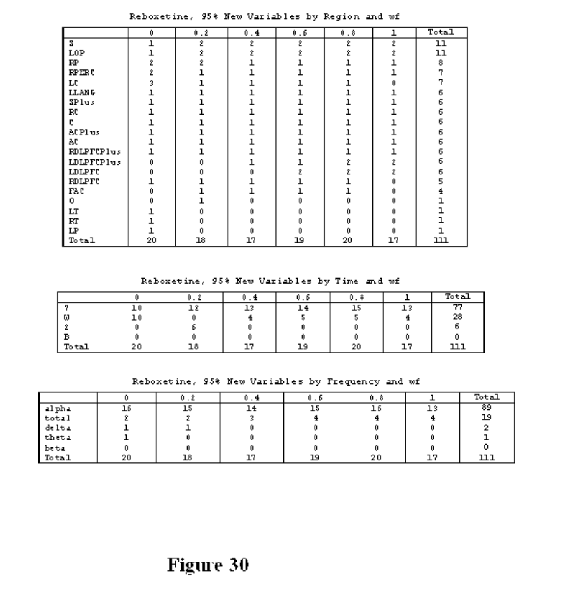

(ii) The 95% variables are shown in FIG. 29 and FIG. 30.

(iii) Tabulation by brain region: the 95% variables came from 21 regions.

(iv) Tabulation by time of measurement: the trend 7>w>2 persisted while no baseline variables attained 95% confidence. As shown in FIG. 30, the 7-day variables were some of the most significant.

(v) Tabulation by frequency band: most were alpha variables while none were beta. In FIG. 30 shows that alpha variables attained the lowest ran ks.

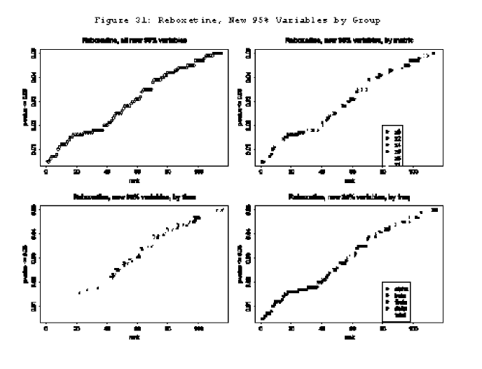

(vi) The above analyses are summarized in FIG. 31.

Venlafaxine, New Variables

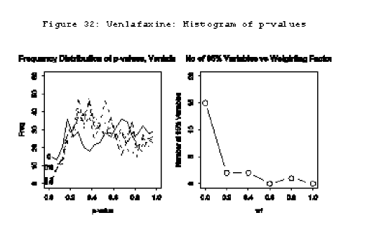

(i) Of the 520*4=2080 new variables (of the type z.wf), only 5 attained 95% confidence. FIG. 32 shows, further, that the number of 95% variables decreased as wf increased.

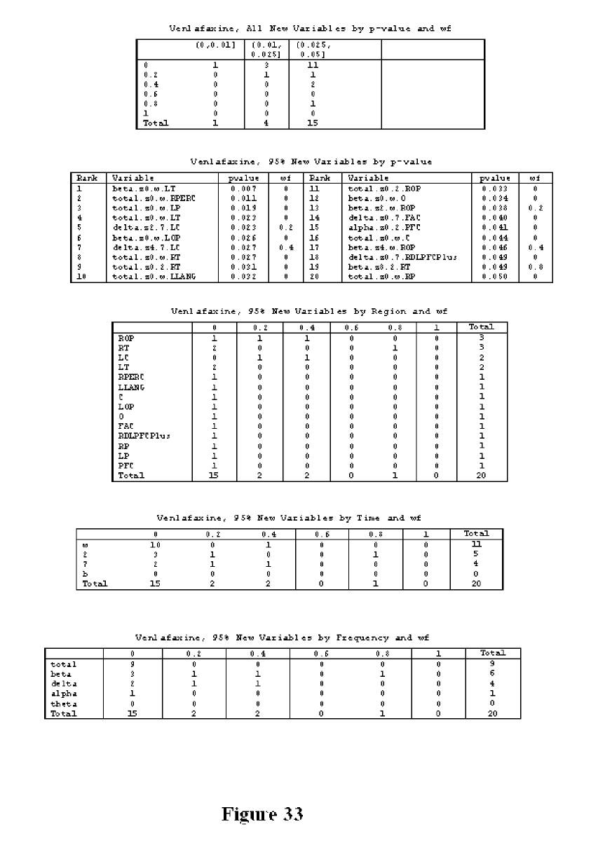

(ii) The 95% variables were these: note only 5 were not relative powers as shown in FIG. 33.

(iii) Tabulation by brain region: the 5 variables came from ROP, RT and LC.

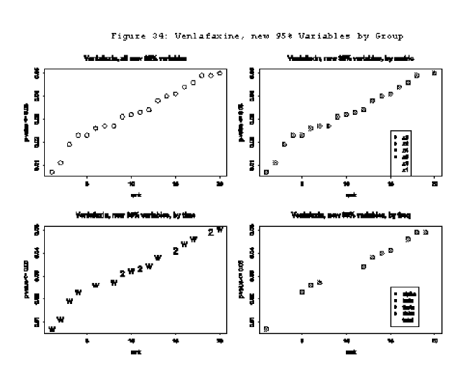

(iv) Tabulation by time of measurement: See also FIG. 34.

(v) Tabulation by frequency band: the 5 variables came from beta or delta band. See also FIG. 34.

(vi) Summary of (ii), (iv), (v) is in FIG. 34.

Extensions

(i) Functions: Other functions of relative and/or absolute powers can be tested and utilized.

(ii) Correlations: It is beneficial to seek a thorough understanding of the correlation matrix relating absolute and relative powers. This analysis informs the search for suitable functions and dimension reduction.

### Example 7

Generating New Variables Using Principal Components Analysis (PCA)

The Rationale:

(i) PCA is used to reduce the dimension of the data. This is important because CART performance is known to deteriorate in the presence of irrelevant variables.

(ii) Since every new variable (known as a principal component) is a linear combination of the original variables, PCA is a method by which the inventors can examine particular linear combinations in our search for cordance-type metrics.

(iii) Performing PCA before CART has the effect of combining variables, allowing CART to extend beyond single-variable splitting. Geometrically, if the inventors think of data as a scatter of points in the space spanned by all variables, then PCA finds a new set of orthogonal axes for the data. CART splits represent horizontal or vertical cuts in the space of data points. If the inventors perform CART using principal components, these cuts are diagonal when viewed under the original axes.

The Methodology:

(i) PCA is a standard statistical technique used for dimension reduction. Principal components, which are linear combinations of the original variables, are uncorrelated and account for most of the total variance of the original variables.

(ii) Because of our small samples, the number of PCA variables is equal to the number of samples.

(iii) The inventors used PCA variables to examine 16 baseline differentiable models. The results were compared to previous findings using Leuchter's cordance.

(iv) The inventors performed t-tests on PCA variables.

The Results:

(i) Principal components: For each model, there are 260 original variables (excluding cordance). These were reduced to 9, 13, 25 and 47 for venlafaxine, fluoxetine, reboxetine and all drugs models respectively. Each PCA variable is a linear combination of 260 original variables and is specified by a vector of weights.

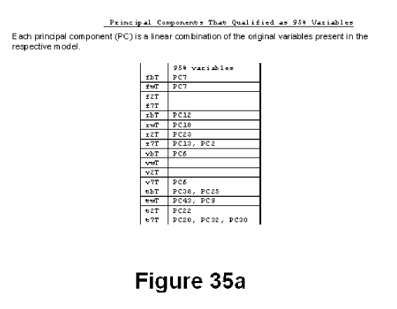

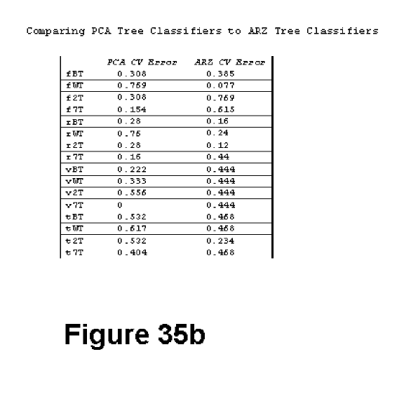

(ii) t-tests: Of the 188 PCA variables generated, the inventors found 18 95% variables as shown in FIG. 35a. There were 4 models that generated no 95% variables at all. As before, 95% variables are those that exhibit statistically different means for the Responder group vs Non-Responder group.

(iil) CART: The inventors found 9 baseline differentiable models with cross-validation errors ranging from 0 to 31% (FIG. 35b). The error rates are shown beside the tree classifiers produced using original data (“ARZ”).

Extensions

(i) Application of other dimension reduction techniques, especially those designed for small samples, have been found to also be useful.

(ii) A further step involves interpretation of how the principal components relate to the original variables. This involves examining if any of the original variables have disproportionate weight on the principal components that were 95% variables or used as splitting variables in tree classifiers.

Ensemble Estimator

Individual simple tree estimators are combined to form an ensemble estimator. Each simple tree estimator (a regional expert) is a one-level classification tree formed using variables from a specified brain region. The ensemble estimator (panel) is shown to have better accuracy than most, often all of, its individual members. Further, the panel is more robust in the sense that it has superior mean and median error rates across different models when compared to the regional experts. By model, the inventors means a baseline differentiable model for a specific drug group and for all drugs. The inventors studied 20 models, namely f, r, v, t, fb, fw, f2, f7, rb, rw, r2, r7, vb, vw, v2, v7, tb, tw, t2, t7 (t=all drugs).

The inventors analyzed two panels: the full panel comprising 26 regional experts; and a small panel of PFC, RP, RPERC experts only. The inventors found the small panel to be clinically useful as it is less prone to over-fitting (an important consideration since data is scarce) while having similar (albeit slightly worse) accuracy and robustness than the full panel.

The small panel is specified thus:

| | Region | Classification Rule | Weight |
|---|---|---|---|
| 1 | PFC | theta.z.w.PFC < 0.098 | 3-Jan |
| 2 | RP | beta.z.b.RP < 0.489 | 3-Jan |
| 3 | RPERC | beta.z.w.RPERC < 0.122 | 3-Jan |

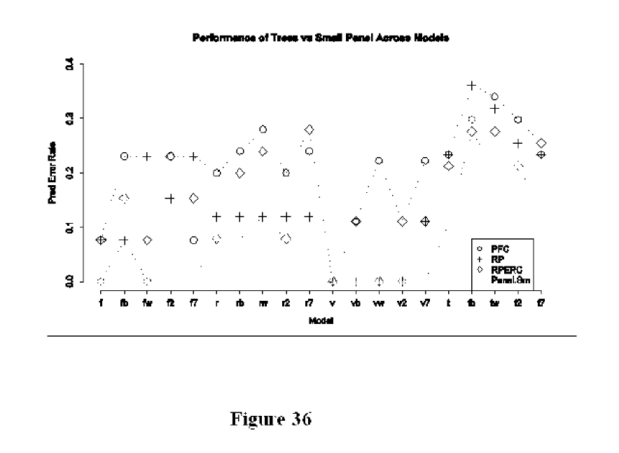

For almost every response model, the panel error rate is lower than that of any individual experts, as shown in FIG. 36. (The pink line, tracing the error rates of the small panel across models, closely resemble the lower bound of error rates. The upper bound of error rates contains only points from regional experts, none from the panel.)

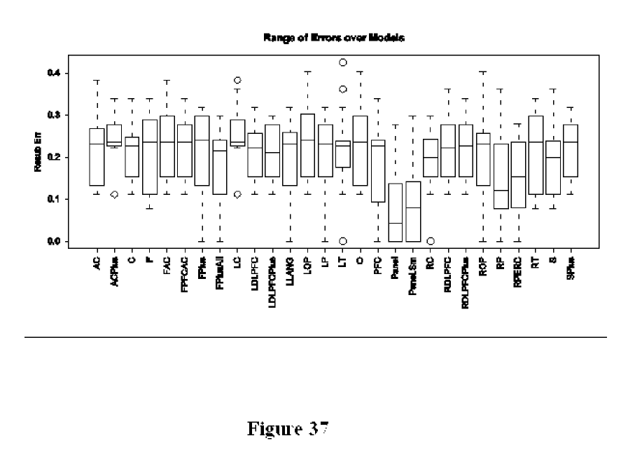

FIG. 37 indicates that panels have significantly lower mean error rates than individual tree estimators, with the means taken over 20 models.

The Rationale:

(i) Taking the consensus vote of a panel of experts leads to a more robust decision than asking just one expert. This procedure is in the spirit of the class of CART enhancements known as bagging and boosting.

(ii) Previously, the inventors showed that 95% variables came from many different brain regions. By using an ensemble tree, the inventors allow variables from different regions to participate in the final decision. This is in contrast to the previous work, where a one-level tree involving one variable from a single brain region was generated for each model (because data is scarce, any larger tree over-fitted the data).

The Methodology:

(i) An ensemble estimator (the “panel”) is created by combining 26 simple tree classifiers (“regional experts”). Each simple classifier is a one-level classification rule due to CART using variables from a single brain region. There are 26 brain regions.

(ii) For each new patient, every simple classifier produces a prediction (responder or non-responder), and the panel vote on the classification, with ties broken randomly. Each member's vote receives equal weight in the current implementation.

(iii) The inventors built ensemble trees for 20 models (fT, rT, vT, tT, fbT, fwT, f2T, f7T, rbT, rwT, r2T, r7T, vbT, vwT, v2T, v7T, tbT, twT, t2T, t7T). The inventors looked for robust classifiers that provide accurate predictions consistently across these models.

(iv) Finally, the inventors examined ensemble trees built from 3 simple classifiers (PFC, RP, RPERC), which is less susceptible to over-fitting.

### 4.3 Illustrative Example

(i) The inventors used model fT to illustrate the concept of ensemble estimation. Similar tabulations can be done for any model upon request.

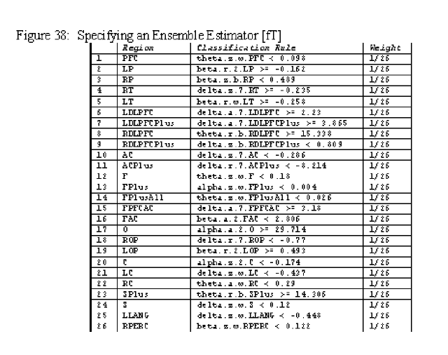

(ii) FIG. 38 specifies an ensemble estimator, including the constituent experts, the respective classification rules and the weights of their votes on the panel.

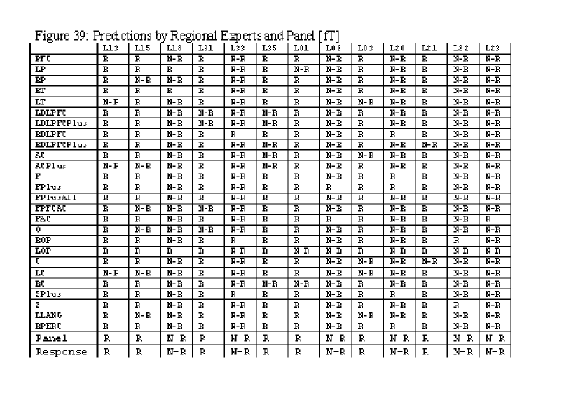

(iii) FIG. 39 displays predictions using the rules stated above. The panel prediction was obtained by combining the 26 separate predictions by the regional experts.

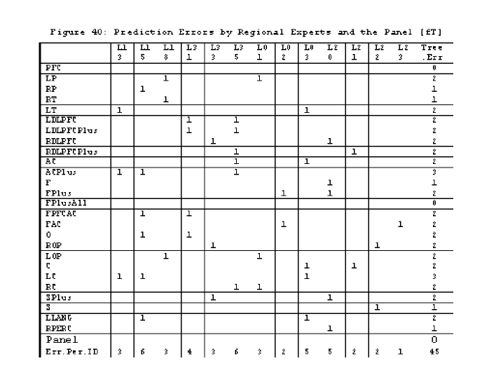

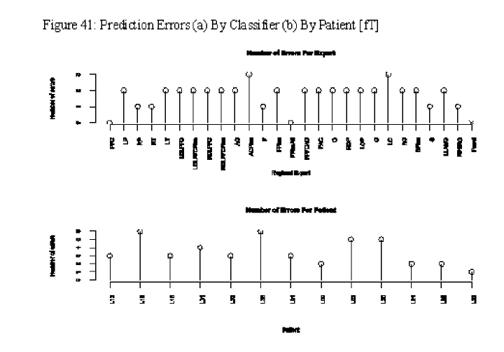

(iii) The prediction errors are shown in FIG. 40 and FIG. 41. Among the regional experts, PFC and FplusAll produced no error while ACPlus and LC committed three errors. The panel made no misclassifications.

(iv) Among patients, the number of errors ranged from 1 to 6. L15 and L35 were the most often misclassified patients. (Again, refer to FIG. 40 and FIG. 41.) This information allows us to identify patients who are outliers.

The Performance Evaluation:

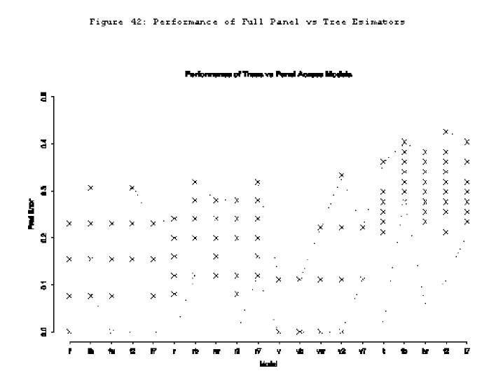

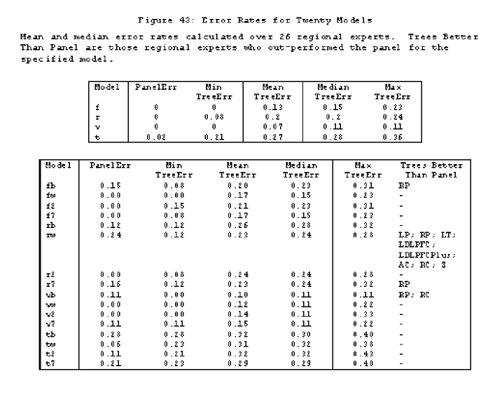

(i) Performance for each model: Combining regional experts led to a clear improvement in resubstitution error rates. In 16 of 20 models, the panel performed no worse than the best individual expert, often substantially better, as seen in FIG. 42. In FIG. 43, the four exceptions were shown to be (fb, RP), (rw, LP, RP, LT, LDLPFC, LDLPFCPlus, AC, RC, S), (r7, RP), and (vb, RP, RC).

In all cases, the panel out-performed the mean and median error rates of regional experts.

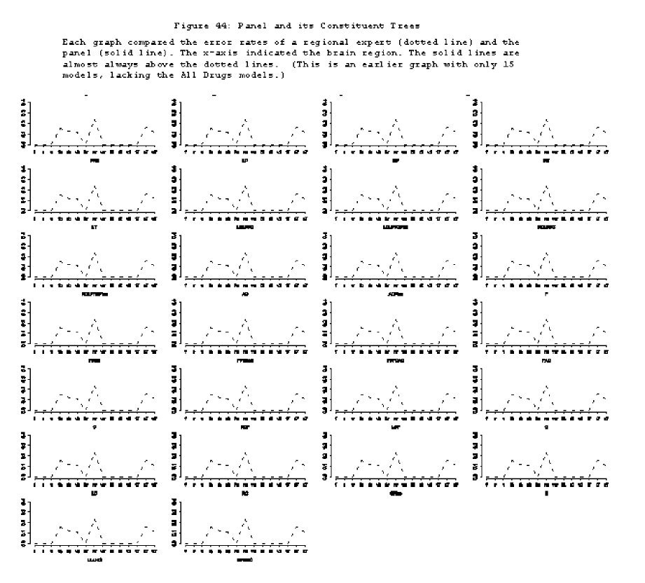

Another view of the data is given in FIG. 44. Each regional expert is compared against the panel over models. The panel is clearly preferred over any individual expert.

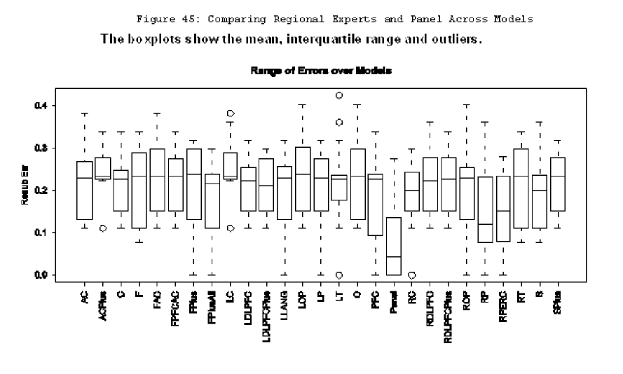

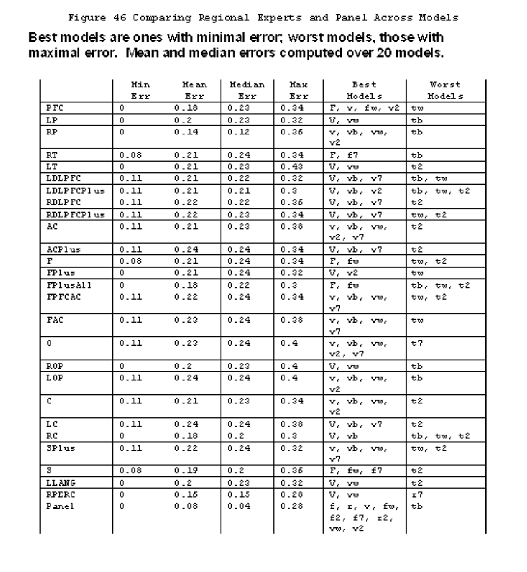

(ii) Robustness over different models: Each regional expert, even if it performed well for certain models, often incurred high error rates for other models. This result is shown graphically in FIG. 45, with details in FIG. 46. In FIG. 46, further highlighted 3 experts used to build a small panel in the next section.

Small Panel

(i) Specification: As before, the ensemble is specified by giving classification rules and weights, as shown FIG. 38 for model fT. Because only 3 regions were used, no tie-breaking was necessary.

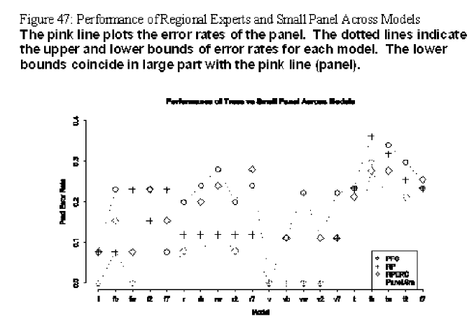

(ii) Performance for each model: In FIG. 47, the inventors saw the small panel out-performed individual regional experts across most models. The error rate of the small panel essentially coincided with the lower bound of all error rates.

(iii) Robustness across models: Further, the inventors observed that the median and mean error rates for the small panel were significantly below those for individual regional experts. The best accuracy was achieved in models for fluoxetine and venlafaxine.

Referring back to FIG. 47, the inventors note that the upper bound for error rates contained points from each regional expert, indicating that such an expert may perform poorly for certain models while performing well for others. The panel is much more consistent.

In terms of regional experts, RP and RPERC appeared to do well for venlafaxine models while RP performed consistently for reboxetine models.

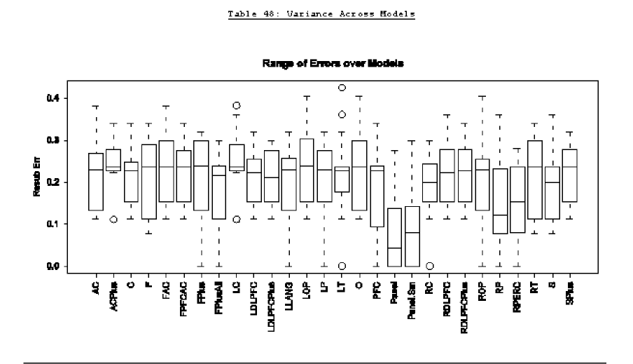

(iv) Small Panel vs. Full Panel: FIG. 48 indicated that the big panel performed slightly better than the small panel in terms of average error rate and dispersion of error rate. This result is explained by the variance-stabilizing feature of bagging and boosting type procedures. The inventors found the small panel to be clinically useful since it much less likely to over-fit the data.

Extensions

(i) Patient outliers: Outliers can be identified by examining the most often misclassified patients. The error rate for each patient can be used as the basis for a boosting procedure, which assigns weights to cases in order to stabilize the variance.

(ii) Error measure: The inventors ascertained that the improvement in performance does not come from over-fitting. The usual preferred method to compare models is test-set error. The inventors also resorted to estimation procedures such as cross-validation and bootstrapping.

(iii) Weighted voting: It is likely true that certain brain regions provide better information or are better predictors than other regions. The weights can be determined by medical expertise, or by statistical procedures (such as gating functions).

(iv) Region selection: More systematic methods can be used to select regional experts for smaller panels.

(v) Panel expertise: Panel members can be experts on frequency or time of measurement.

(vi) Variance stabilization: The variance of error rates can be further reduced using standard procedures such as boosting.

### Example 8

Homeland Security Ideas for QEEG Analysis for Veracity Verification and/or Lie Detection.

Dr. Langleben at the U. of Pennsylvania has shown with fMRI that there was increased blood flow in the anterior cingulate and the adjacent right superior frontal gyrus when individuals lied. Separately, Dr. Lawrence Farwell is developing analysis of p300 wave pattern testing for lie detection.

fMRI is not field deployable. QEEG techniques have been shown to be highly correlated with PET (such as with theta cordance values), SPECT and also can demonstrate hyper and hypo-metabolism of brain regions as shown with fMRI. QEEG analysis can:

1). provide a mobile field deployable technology that provides the same information that fMRI researchers are looking at.

2). Supercede p300 work, since that analysis could be incorporated into the QEEG analysis.

3). Provide additional cordance, coherence and other analysis adding to the evaluation (including other wave patterns).

Therefore, the technology entailed in this patent application has veracity verification and/or lie detection applications, and can aid in obtaining information without torture, either by being stand-alone technology, or when used in conjunction with regular lie detection methods incorporating GSR, RR, HR, BP, thermal imaging, voice analysis, etc.

### Example 9

Al methods to predict diagnosis and treatment response for rheumatological and other medical diseases, including rheumatoid arthritis, systemic lupus erythematosis and other conditions:

Application of competitive evolution, in addition to single Al methods, for predictive systems is employed. Machine learning methodologies are applied. Various strategies are used to compete against each other to find relationships in datasets. The strategies include data mining (where a fitness function is used to eliminate irrelevant and redundant variables: variables found to have highest fitness function and included for analysis were LE cell presence, anti-double stranded DNA titer, ANA titer, WBC level, HCT level, Schirmer's test, good response to steroid therapy, fever, absence of joint pains localized to a single joint, history of joint swelling at three or more peripheral joints, gender, and CPK (other factors can have fitness with other models)), C 4.5 (or later versions) decision tree induction system, C 4.5 (or later versions) rules extraction tool, LFC++ constructive induction program, conjugate gradient descent feedforward neural network, genetic programming algorithms, standard linear regression methodology, support vector machine, perceptual model analysis, and equation finding tools. The Al program trained on systemic lupus erthematosis (SLE) data vs. data from a general (non-SLE) rheumatological population. The Al program also trained on rheumatoid arthritis (RA) data vs. data from a general (non-RA) rheumatological population. After training the Al model, then the best learning agent for each condition was tested on separate test data sets (which was prepared prior to the training, prepared to be of equivalent difficultly for diagnosis, and used data not used in the training set). Results had accuracy of 96% to 100% in making diagnoses of several rheumatological diseases from databases of difficult cases. Results demonstrated a test accuracy of 96.32% for accurately diagnosing cases of systemic lupus erythematosis, and 100% accuracy in diagnosing cases of rheumatoid arthritis, and showing better accuracy of prediction that by board certified specialists who averaged accuracy of prediction of less than 94% for distinguishing cases of systemic lupus erythematosis and rheumatoid arthritis for the difficult data set used. Separate CART analysis of the test data set (not using Al methods) produced 100% accuracy of diagnosis of these 2 conditions, corroborating the use machine learning and/or CART methods to accurately produce medical diagnoses for various medical conditions.

### CONCLUSION

Although the present invention has been described in considerable detail with reference to certain preferred versions thereof, other versions are possible. Therefore, the point and scope of the appended claims should not be limited to the description of the preferred versions contained herein.

A further refinement of the system and method of the present invention is to incorporate features derived from the EEG with features derived from analysis of images of the structure under examination (e.g., the brain). Such images may be obtained from CAT (computer-aided tomography), MRI (magnetic resonance imaging), PET (positron emission tomography), X-ray and other modalities. Yet another refinement is to incorporate both features derived from the EEG with features derived from the analysis of images of the function of the structure under analysis. Images of function such as glucose metabolism may be obtained with techniques such as functional PET imaging. Features derived from metrics of the instantaneous or time-averaged glucose metabolism in the entire brain or a specified sub-region of the brain may be combined in an index of CNS function to quantify cognitive function, disease state, disease progression, and other parameters of interest.

Other methods may include fMRI, magnetic resonance spectroscopy, magnetoencephalography, etc.

The invention further enables better treatment, by prospectively evaluating putative treatments for diagnosed disorders. Some such disorders include, without being limited to the recited list, the following: agitation, attention deficit hyperactivity disorder, atypical asthma, Alzheimer's disease/dementia, anxiety, panic, and phobic disorders, bipolar disorders, borderline personality disorder, behavior control problems, body dysmorphic disorder, atypical cardiac arrthymias including variants of sinus tachycardia, autoimmune diseases, intermittent sinus tachycardia, sinus bradycardia and sinus arrthymia, cognitive problems, atypical dermatitis, depression, dissociative disorders, eating disorders such as bulimia, anorexia and atypical eating disorders, appetite disturbances and weight problems, edema, fatigue, atypical headache disorders, atypical hypertensive disorders, hiccups, impulse-control problems, irritability, atypical irritable bowel disorder, mood problems, movement problems, multiple sclerosis, neurological disorders, neuromuscular disorders, obsessive-compulsive disorder, pain disorders, personality disorders, posttraumatic stress disorder, schizophrenia and other psychotic disorders, seasonal affective disorder, sexual disorders, sleep disorders including sleep apnea and snoring disorders, stuttering, substance abuse, tic disorders/Tourette's Syndrome, traumatic brain injury, trichotillomania, viral infections or associated disorders, or violent/self-destructive behaviors.

In this aspect of the invention, the invention guides choices for treating the above-listed psychiatric, autoimmune, medical, cardiac, neurological, neuroendocrine, neuromuscular, viral and viral associated disorders with various therapeutic regimes, including, but not limited to: therapeutic entity therapy, drug therapy, phototherapy (light therapy), electroconvulsive therapy, electromagnetic therapy, neuromodulation therapy, transcutaneous magnetic stimulation, vagal nerve stimulation, verbal therapy, and other forms of therapy.

Optionally, the method includes scenarios wherein the brain pathology is selected from the group consisting of agitation, Attention Deficit Hyperactivity Imbalance, Abuse, Alzheimer's disease/dementia, anxiety, panic, and phobic disorders, bipolar disorder, borderline personality disorder, behavior control problems, body dysmorphic disorders, cognitive problems, Creutzfeldt-Jakob disease, depression, dissociative disorders, eating, appetite, and weight problems, edema, fatigue, hiccups, impulse-control problems, irritability, jet lag, mood problems, movement problems, obsessive-compulsive disorder, pain, personality imbalances, posttraumatic stress disorder, schizophrenia and other psychotic disorder, seasonal affective disorder, sexual disorder, sleep disorder, stuttering, substance abuse, tic disorder/Tourette's Syndrome, traumatic brain injury, trichotillomania, Parkinson's disease, violent/self-destructive behaviors, and any combination thereof.

The invention also encompasses a method wherein the treatment modality is selected from the group consisting of drug therapy, electroconvulsive therapy, electromagnetic therapy, neuromodulation therapy, transcutaneous magnetic stimulation, magnetotherapy, talk therapy, use of any other treatment modality, and any combination thereof. Optionally, the treatment modality is drug therapy and the drug is selected from the group consisting of a psychotropic agent, a neurotropic agent, a multiple of a phychotropic agent or a neurotropic agent, any other agent, and any combination thereof. Optionally, the drug has a direct or indirect effect on the CNS system of the patient. And, optionally, the drug is selected from the group consisting of but not limited to alprazolam, amantadine, amitriptyline, atenolol, bethanechol, bupropion, buspirone, carbamazepine, chlorpromazine, chlordiazepoxide, citalopram, clomipramine, clonidine, clonazepam, clozapine, cyproheptadine, dexamethasone, divalproex, deprenyl, desipramine, dexamethasone, dextroamphetamine, diazepam, disulfram, divalproex, doxepin, duloxetine, ethchlorvynol, fluoxetine, fluvoxamine, felbamate, fluphenazine, gabapentin, haloperidol, imipramine, isocarboxazid, lamotrigine, levothyroxine, liothyronine, lithium carbonate, lithium citrate, lorazepam, loxapine, maprotiline, meprobamate, mesoridazine, methamphetamine, midazolam, meprobamate, mirtazapine, molindone, moclobemide, molindone, naltrexone, pheneizine, nefazodone, nortriptyline, olanzapine, oxazepam, paroxetine, pemoline, perphenazine, pheneizine, pimozide, pindolol, prazepam, propranolol, protriptyline, quetiapine, reboxetine, risperidone, selegiline, sertraline, sertindole, trifluoperazine, trimipramine, temazepam, thioridazine, topiramate, tranylcypromine, trazodone, triazolam, trihexyphenidyl, trimipramine, valproic acid, venlafaxine, other agents listed in claims above, other drugs, as a single agent or combination, or any other agent or method including future approved agents or methods used to treat the condition, or used as an off label use for the condition.

With respect to the above description, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

What is claimed is:

1. A medication treatment selection strategy comprising: predicting response to medication with high to complete accuracy at baseline, selected from a group of using a one week single blind placebo treatment, active medication, placebo treatment for a given period of any time length, using QEEG, and other imaging data analysis.

2. A medication treatment selection strategy base on claim 1 which includes using standard T-test methods with cordance, absolute and relative regional and/or single point data.

3. A medication treatment selection strategy base on claim 1 which includes an analysis of all variables for importance in developing CART models.

4. A medication treatment selection strategy based on claim 3 in which single point cordance or absolute data were of importance.

5. A medication treatment selection strategy based on claim 3 which includes using time-series regional weighted factor analysis with CART.

6. A medication treatment selection strategy based on claim 3 which includes using time-series regional principal components analysis (PCA) with CART.

7. A treatment selection strategy based on claim 3 whereby with the use of time-series regional principal components analysis (PCA) or panel/ensemble analysis with CART, that relative data (and with specific medication cases, absolute data) can be used as effectively as cordance data in accurately predicting response, and that relative and cordance data were found to be superior in PCA or panel/ensemble analysis to use of absolute data for predicting treatment response with some specific antidepressants.

8. A treatment selection strategy based on claim 3 whereby accurate results were obtained with PCA and panel/ensemble analysis of relative (and/or absolute data), without the need for cordance calculation.

9. A treatment selection strategy based on claim 3 whereby empirical finding confirmed that ensemble/panel methods generally outperform component classifiers; and that ensemble/panel analyses are more robust over multiple data sets.

10. A treatment selection strategy based on claim 3 whereby panel analysis was found to be most effective, and PCA analysis showed that the assumptions of the formulas used for cordance calculations are arbitrary and do not provide the best results in predicting treatment response, that instead of a 2 axis method, other methods, such as utilizing a single axis to separate treatment responders from treatment non-responders (or to separate all groups of treat responders, treatment non-responders, placebo responders and placebo non-responders) can produce superior results to utilizing the standard cordance methods, with lower cross validation error and re-substitution error rates (thus improving the robustness of the methodology).

11. A treatment selection strategy based on claim 3 whereby said strategy improves clinical utility of results for psychiatric, neurologic and other applications, including specifically, but not limited to, antidepressant medication use and antipsychotic medication use.

12. A medication treatment selection strategy based on claim 3 which includes using panel/ensemble analysis with CART.

13. A medication treatment selection strategy based on claim 3 which includes using a single axis to separate treatment responders from treatment non-responders.

14. A medication treatment selection strategy based on claim 3 which includes analyzing genomic and or pharmacogenomic data, which may include one or more of pharmacokinetic or pharmacodynamic data, or pharmacoproteomic or biochemical or psychological or nutritional or environmental or social or psychodiagnostic test data, or imaging data.

15. A method of clinical models to determine treatment response as in claim 14, with or without the use of genomic, pharmacogenomic, proteomic, pharmacoproteomic, physiological parameters, biochemical and other diagnostic tests.

16. A method of clinical models to determine treatment response as in claim 14, with or without the use of genomic, pharmacogenomic, proteomic, pharmacoproteomic methods and data, physiological parameters, biochemical and other diagnostic tests.

17. A treatment selection strategy based on claim 14 that can be used to select the optimal dose(s) for medication treatment, optimal time(s) for treatment, optimal inclusion or exclusion of other modality of treatment, and optimal level of other treatment modality if so included in treatment.

18. A method of clinical models to determine treatment response as in claim 14 being used for antidepressant medication use.

19. A method of clinical models to determine treatment response as in claim 14 being used for antipsychotic medication use.

20. A method of clinical models to determine treatment response as in claim 14 being used for other psychiatric, neurologic, autoimmune, rheumatological or other medical condition use.

21. A method of clinical models to determine diagnostic category as in claim 15 being used to very accurately predict medical diagnosis at a level of accuracy superior to human specialty trained experts.

22. A method of clinical models to determine treatment response as in claim 14 whereby said being used to very accurately predict medical diagnosis at a level of accuracy superior to human specialty trained experts.

23. A method of clinical models to determine treatment response as in claim 14 whereby being used as a method for individual statement veracity verification and/or lie detection.

24. A method of clinical models to determine treatment response as in claim 15 being used as a method for individual statement veracity verification and/or lie detection.

25. A method of clinical models to determine treatment response as in claim 14 being used to select the optimal dose for medication treatment, optimal time for treatment, and optimal level of other treatment modality for other form of treatment.

26. A method of clinical models to determine treatment response as in claim 14 comprising the use of pharmacogenomic analysis and use of QEEG imaging (or other imaging method), with or without the use of CART, artificial intelligence or other statistical or mathematical methods, and with or without the use of other diagnosis methods.

27. The method of claim 14 wherein the traditional diagnosis is psychological factors affecting medical condition, and a treatment is selected from the group consisting of gaba glutamine, phenylalanine, tyrosine, 5-HT, S-adenosylmethioinine, omega-3 fatty acids, donepezil, buproprion, escitalopram, citalopram, sertraline, clomiprimine, doxepin, fluoxetine, fluvoxamine, moclobemide, parnate, phenalzine, seligeline, trazodone, venlafaxine, carbamazapine, diphenylhydantoin, divalproex, gabapentin, lamotrigine, guanfacine hcl, clorazepate, diazapam, oxazepam, quazepam, atenolol, metopolol, propranolol, lithium, ginko biloba, st. john's wort, silbtrimin, amantadine, phototherapy at 10000 lux, adderall, dexedrine, methapmphetamine, methylphenidate, modafinil, phentermine, venlafaxine, duloxetine, mirtazapine, gepirone, topiramate, gabatril, trazodone, tricyclic or tetracycline antidepressant, typical or atypical antipsychotic, anxiolytic sedative, whether of benzodiazepine or non-benzodiazepine class, nutritional or botanical supplement, as a single agent or combination, or any other agent or method affecting psychological factors affecting medical condition, including future approved agents used to treat the condition, or used as an off label use for the condition.

28. The method of claim 14 wherein the traditional diagnosis is one of anxiety disorders and a treatment is selected from the group consisting of gaba, glutamine, phenylalanine, tyrosine, 5-HT, S-adenosylmethioinine, omega-3 fatty acids, buproprion, fluoxetine, escitalopram, citalopram, fluvoxamine, paroxetine, sertraline, citalopramine, clomipramine, moclobemide, parnate, phenalzine, buspirone, seligeline, carbamazapine, divalproex, gabapentin, lamotrigine, guanfacine hcl, clonidine, atenolol, metopolol, propranolol, lithium, ginko biloba, st. john's wort, amantadine, phototherapy at 10000 lux, venlafaxine, duloxetine, mirtazapine, gepirone, topiramate, gabatril, nefazodone, trazodone, tricyclic or tetracycline antidepressant, typical or atypical antipsychotic, anxiolytic-sedative/hypnotic, whether of benzodiazepine (including but not limited to alprazolam, chlordiazepoxide, clonazepam, chlorazepate, diazepam, halzepam, lorazepam, oxazepam, temazepam, flurazepam, estazolam, triazolam) or non-benzodiazepine class (including but not limited to buspirone, hydroxazine, zolpidem, zaleplon, diphenhyrdamine, choral hydrate), nutritional or botanical supplement, as a single agent or combination, or any other agent or method affecting anxiety disorders, including future approved agents used to treat the condition, or used as an off label use for the condition.

29. The method of claim 14 wherein the traditional diagnosis is one of medical factors affecting psychological condition, and a treatment is selected from the group consisting of gaba glutamine, phenylalanine, tyrosine, 5-HT, S-adenosylmethioinine, omega-3 fatty acids, donepezil, buproprion, sertraline, escitalopram, citalopram, clomiprimine, doxepin, fluoxetine, fluvoxamine, moclobemide, parnate, phenalzine, seligeline, trazodone, venlafaxine, carbamazapine, diphenylhydantoin, divalproex, gabapentin, lamotrigine, guanfacine hcl, clorazepate, diazapam, oxazepam, quazepam, atenolol, metopolol, propranolol, lithium, ginko biloba, st. john's wort, silbtrimin, amantadine, phototherapy at 10000 lux, adderall, dexedrine, methapmphetamine, methylphenidate, modafinil, phentermine, venlafaxine, duloxetine, mirtazapine, gepirone, topiramate, gabatril, trazodone, tricyclic or tetracycline antidepressant, typical or atypical antipsychotic, anxiolytic sedative, whether of benzodiazepine or non-benzodiazepine class, nutritional or botanical supplement, as a single agent or combination, or any other agent or method affecting medical factors affecting psychological condition, including future approved agents used to treat the condition, or used as an off label use for the condition.

30. The method of claim 14 wherein the traditional diagnosis is one of eating disorders and a treatment is selected from the group consisting gaba glutamine, phenylalanine, tyrosine, 5-HT, S-adenosylmethioinine, omega-3 fatty acids, donepezil, buproprion, fluoxetine, escitalopram, citalopram, clomiprimine, doxepin, fluoxetine, sertraline, fluvoxamine, moclobemide, parnate, phenalzine, seligeline, trazodone, venlafaxine, carbamazapine, diphenylhydantoin, divalproex, gabapentin, lamotrigine, guanfacine hcl, clorazepate, diazapam, oxazepam, quazepam, atenolol, metopolol, propranolol, lithium, ginko biloba, st. john's wort, silbtrimin, amantadine, diphenylhydantoin, phototherapy at 10000 lux, adderall, dexedrine, methapmphetamine, methylphenidate, modafinil, pemoline, phentermine, venlafaxine, duloxetine, mirtazapine, gepirone, topiramate, gabatril, trazodone, tricyclic or tetracycline antidepressant, typical or atypical antipsychotic, anxiolytic sedative, whether of benzodiazepine or non-benzodiazepine class, nutritional or botanical supplement, as a single agent or combination, or any other agent or method affecting eating disorders, including future approved agents used to treat the condition, or used as an off label use for the condition.

31. The method of claim 14 wherein the traditional diagnosis is one of delirium, dementia and amnestic and other cognitive disorders and a treatment is selected from the group consisting of glutamine, phenylalanine, tyrosine, omega-3 fatty acids, donepezil, memantine, rivastigmine, galantamine, tacrine, amitriptyline, buproprion, fluxotine, moclobemide, parnate, phenalzine, seligeline, venlafaxine, carbamazapine, divalproex, gabapentin, lamotrigine, atenolol, metopolol, propranolol, lithium, ginko biloba, silbtrimin, amantadine, phototherapy at 10000 lux, zolipidem, adderall, dexedrine, methapmphetamine, methylphenidate, modafinil, pemoline, phentermine, trazodone, SSRI, SNRI, MAOI, nefazodone, mirtazapine, tricyclic or tetracycline antidepressant, typical or atypical antipsychotic, anxiolytic sedative, whether of benzodiazepine or non-benzodiazepine class, nutritional or botanical supplement, as a single agent or combination, or any other agent or method affecting delirium, dementia and amnestic and other cognitive disorders, including future approved agents used to treat the condition, or used as an off label use for the condition.

32. The method of claim 14 wherein the traditional diagnosis is impulse control disorders not elsewhere classified and a treatment is selected from the group consisting of glutamine, phenylalanine, tyrosine, omega-3 fatty acids, donepezil, amitriptyline, buproprion, fluoxetine, moclobemide, parnate, phenalzine, seligeline, venlafaxine, carbamazapine, divalproex, gabapentin, lamotrigine, atenolol, metopolol, propranolol, lithium, ginko biloba, silbtrimin, amantadine, phototherapy at 10000 lux, zolipidem, adderall, dexedrine, methapmphetamine, methylphenidate, modafinil, pemoline, phentermine, memantine, rivastigmine, galantamine, trazodone, SSRI, SNRI, MAOI, nefazodone, mirtazapine, other tricyclic or tetracycline antidepressant, typical or atypical antipsychotic, anxiolytic sedative, whether of benzodiazepine or non-benzodiazepine class, nutritional or botanical supplement, as a single agent or combination, or any other agent or method affecting impulse control disorders, including future approved agents used to treat the condition, or used as an off label use for the condition.

33. The method of claim 14 wherein the traditional diagnosis is one of mood disorders and a treatment is selected from the group consisting of gaba, glutamine, phenylalanine, tyrosine, 5-HT, S-adenosylmethioinine, omega-3 fatty acids, buproprion, fluoxetine, reboxetine, escitalopram, citalopram, fluvoxamine, paroxetine, sertraline, citalopramine, clomipramine, moclobemide, parnate, phenalzine, buspirone, seligeline, carbamazapine, divalproex, gabapentin, lamotrigine, guanfacine hcl, clonidine, atenolol, metopolol, propranolol, lithium, ginko biloba, st. john's wort, amantadine, phototherapy at 10000 (or any other) lux, venlafaxine, duloxetine, mirtazapine, gepirone, topiramate, gabatril, nefazodone, trazodone, tricyclic or tetracycline antidepressant, typical or atypical antipsychotic (including but not limited to olanzapine, risperidone, quetiapine, ziprasodone, aripiprazole), triiodothyronine, T4, estrogen and progesterone compounds and derivatives (SERMs, etc), adderall, dexedrine, methapmphetamine, methylphenidate, modafinil, pemoline, phentermine, anxiolytic sedative, whether of benzodiazepine or non-benzodiazepine class, nutritional or botanical supplement, as a single agent or combination, or any other agent or method affecting mood disorders, including future approved agents used to treat the condition, or used as an off label use for the condition.

34. The method of claim 14 wherein the traditional diagnosis is one of personality disorders and a treatment is selected from the group consisting of gaba, glutamine, phenylalanine, tyrosine, 5-HT, S-adenosylmethioinine, omega-3 fatty acids, buproprion, reboxetine, fluoxetine, escitalopram, citalopram, fluvoxamine, paroxetine, sertraline, citalopramine, clomipramine, moclobemide, parnate, phenalzine, buspirone, seligeline, carbamazapine, divalproex, gabapentin, lamotrigine, guanfacine hcl, clonidine, atenolol, metopolol, propranolol, lithium, ginko biloba, st. john's wort, amantadine, phototherapy at 10000 lux, venlafaxine, duloxetine, mirtazapine, gepirone, topiramate, gabatril, nefazodone, trazodone, tricyclic or tetracycline antidepressant, typical or atypical antipsychotic (including but not limited to olanzapine, risperidone, quetiapine, ziprasodone, aripiprazole), triiodothyronine, T4, estrogen and progesterone compounds and derivatives (SERMs, etc), anxiolytic sedative, whether of benzodiazepine or non-benzodiazepine class, nutritional or botanical supplement, as a single agent or combination, or any other agent or method affecting personality disorders, including future approved agents used to treat the condition, or used as an off label use for the condition.

35. The method of claim 14 wherein the traditional diagnosis is hypoactive sexual desire disorder and a treatment is selected from the group consisting of buproprion, buspirone, moclobemide, pamate, phenalzine, seligeline, yohimbine, venlafaxine, duloxetine, mirtazapine, nefazodone, trazodone, herbal and/or nutritional supplements as a single agent or in combination, typical or atypical antipsychotic (including but not limited to olanzapine, risperidone, quetiapine, ziprasodone, aripiprazole), anxiolytic sedative, whether of benzodiazepine or non-benzodiazepine class, or any other agent or method affecting hypoactive sexual disorder, including future approved agents used to treat the condition, or used as an off label use for the condition.

36. The method of claim 14 wherein the traditional diagnosis is one of sleep disorders and a treatment is selected from the group consisting of a anxiolytic and/or sedative/hypnotic, whether of benzodiazepine (including but not limited to alprazolam, chlordiazepoxide, clonazepam, chlorazepate, diazepam, halzepam, lorazepam, oxazepam, temazepam, flurazepam, estazolam, triazolam) or non-benzodiazepine class (including but not limited to buspirone, hydroxazine, zolpidem, zaleplon, diphenhyrdamine, choral hydrate), barbiturate, gaba, glutamine, phenylalanine, tyrosine, 5-HT, S-adenosylmethioinine, omega-3 fatty acids, buproprion, fluoxetine, escitalopram, citalopram, fluvoxamine, paroxetine, sertraline, citalopramine, clomipramine, moclobemide, parnate, phenalzine, buspirone, seligeline, carbamazapine, divalproex, gabapentin, lamotrigine, guanfacine hcl, clonidine, atenolol, metopolol, propranolol, lithium, ginko biloba, st. john's wort, amantadine, phototherapy at 10000 lux, venlafaxine, duloxetine, mirtazapine, gepirone, topiramate, gabatril, nefazodone, trazodone, tricyclic or tetracycline antidepressant, typical or atypical antipsychotic (including but not limited to olanzapine, risperidone, quetiapine, ziprasodone, aripiprazole), nutritional or botanical supplement, as a single agent or combination, or any other agent or method affecting sleep disorders, including future approved agents used to treat the condition, or used as an off label use for the condition.

37. The method of claim 14 wherein the traditional diagnosis is one of somatoform disorders and a treatment is selected from the group consisting of gaba, glutamine, phenylalanine, tyrosine, 5-HT, S-adenosylmethioinine, omega-3 fatty acids, fluoxetine, buproprion, escitalopram, citalopram, fluvoxamine, paroxetine, sertraline, citalopramine, clomipramine, moclobemide, parnate, phenalzine, buspirone, seligeline, carbamazapine, divalproex, gabapentin, lamotrigine, guanfacine hcl, clonidine, atenolol, metopolol, propranolol, lithium, ginko biloba, st. john's wort, amantadine, phototherapy at 10000 lux, venlafaxine, duloxetine, mirtazapine, gepirone, topiramate, gabatril, nefazodone, trazodone, tricyclic or tetracycline antidepressant, typical or atypical antipsychotic (including but not limited to olanzapine, risperidone, quetiapine, ziprasodone, aripiprazole), triiodothyronine, T4, anxiolytic sedative, whether of benzodiazepine or non-benzodiazepine class, nutritional or botanical supplement, as a single agent or combination, or any other agent or method affecting somatoform disorders, including future approved agents used to treat the condition, or used as an off label use for the condition.

38. The method of claim 14 wherein the traditional diagnosis is one of substance-related disorders and a treatment is selected from the group consisting of clonidine, disulfuram, methadone, naltexone, buprenorphine, gaba, glutamine, phenylalanine, tyrosine, 5-HT, S-adenosylmethioinine, omega-3 fatty acids, buproprion, fluoxetine, reboxetine, escitalopram, sertraline, citalopram, fluvoxamine, paroxetine, citalopramine, clomipramine, moclobemide, parnate, phenalzine, buspirone, seligeline, carbamazapine, divalproex, gabapentin, lamotrigine, guanfacine hcl, clonidine, atenolol, metopolol, propranolol, lithium, ginko biloba, st. john's wort, amantadine, adderall, dexedrine, methapmphetamine, methylphenidate, modafinil, pemoline, phentermine, phototherapy at 10000 lux, venlafaxine, duloxetine, mirtazapine, gepirone, topiramate, gabatril, nefazodone, trazodone, tricyclic or tetracycline antidepressant, typical or atypical antipsychotic, anxiolytic sedative, whether of benzodiazepine or non-benzodiazepine class, nutritional or botanical supplement, as a single agent or combination, or any other agent or method affecting substance related disorders, including future approved agents used to treat the condition, or used as an off label use for the condition.

39. The method of claim 14 wherein the traditional diagnosis is a psychotic disorder and a treatment is selected from the group consisting of typical (including but not limited to haloperidol, fluphenazine, pimozide, thiothixine, trifluoperazine, loxapine, molindone, perphenazine, chlorpromazine, mesorizadine, thiorizadine, clozapine) or atypical antipsychotic (including but not limited to clozapine, sertindole, olanzapine, risperidone, quetiapine, ziprasodone, aripiprazole), cycloserine, gaba, glutamine, phenylalanine, tyrosine, 5-HT, S-adenosylmethioinine, omega-3 fatty acids, buproprion, fluoxetine, escitalopram, citalopram, fluvoxamine, paroxetine, sertraline, citalopramine, clomipramine, moclobemide, parnate, phenalzine, buspirone, seligeline, carbamazapine, divalproex, gabapentin, lamotrigine, guanfacine hcl, clonidine, atenolol, metopolol, propranolol, lithium, ginko biloba, st. john's wort, amantadine, phototherapy at 10000 lux, venlafaxine, duloxetine, mirtazapine, gepirone, topiramate, gabatril, nefazodone, trazodone, tricyclic or tetracycline antidepressant, triiodothyronine, T4, anxiolytic sedative, whether of benzodiazepine or non-benzodiazepine class, antiparkinsonian drug (including but not limited to benztropine, trihexiphenidyl, biperiden, amantadine, diphenhydramine), nutritional or botanical supplement, as a single agent or combination, or any other agent or method affecting a psychotic disorder, including future approved agents used to treat the condition, or used as an off label use for the condition.

40. The method of claim 14 wherein the traditional diagnosis is one of attention deficit disorders or attention deficit hyperactivity disorders, and a treatment is selected from the group consisting of phenylalanine, tyrosine, S-adenosylmethioinine, omega-3 fatty acids, buproprion, citalopramine, clomipramine, moclobemide, parnate, phenalzine, buspirone, seligeline, phototherapy at 10000 lux, venlafaxine, duloxetine, triiodothyronine, T4, adderall, dexedrine, methapmphetamine, methylphenidate, modafinil, pemoline, phentermine, anxiolytic sedative, whether of benzodiazepine or non-benzodiazepine class, nutritional or botanical supplement, as a single agent or combination, or any other agent or method affecting attention deficit disorder or attention deficit hyperactivity disorders, including future approved agents used to treat the condition, or used as an off label use for the condition.

41. The method of claim 14 wherein the traditional diagnosis is one of other codes and conditions (including but not limited to adjustment disorders, neurological disorders, neuromuslcular disorders, HIV encephalopahthy, HIV and other viral infections, rheumatological conditions, etc.) and a treatment is selected from the group consisting of an antiepileptic drug(s), an antiparkinson drug(s), an antiviral drug(s), an interferon(s), and interleukin(s), an anti-inflammatory drug(s), gaba, glutamine, phenylalanine, tyrosine, 5-HT, S-adenosylmethioinine, omega-3 fatty acids, buproprion, fluoxetine, reboxetione, escitalopram, citalopram, fluvoxamine, paroxetine, sertraline, citalopramine, clomipramine, moclobemide, parnate, phenalzine, buspirone, seligeline, carbamazapine, divalproex, gabapentin, lamotrigine, guanfacine hcl, clonidine, atenolol, metopolol, propranolol, lithium, ginko biloba, st. john's wort, amantadine, phototherapy at 10000 lux, venlafaxine, duloxetine, mirtazapine, gepirone, topiramate, gabatril, nefazodone, trazodone, tricyclic or tetracycline antidepressant, typical or atypical antipsychotic (including but not limited to olanzapine, risperidone, quetiapine, ziprasodone, aripiprazole), triiodothyronine, T4, anxiolytic sedative, whether of benzodiazepine or non-benzodiazepine class, nutritional or botanical supplement, as a single agent or combination, or any other agent or method affecting other codes and conditions, including future approved agents used to treat the condition, or used as an off label use for the condition.
